(19) United States
(12) Patent Application Publication
(10) Pub. No.: US 2023/0061300 A1
(43) Pub. Date: Mar. 2, 2023

(54) MINERAL-BASED COMPOSITES

(71) Applicant: PACT RENEWABLES PTY LTD, Thornleigh (AU)

(72) Inventors: Aharon ARAKEL, Thornleigh (AU); Bithi ROY, Thornleigh (AU); Rubick ARAKEL, Thornleigh (AU)

(73) Assignee: PACT RENEWABLES PTY LTD, Thornleigh (AU)

(21) Appl. No.: 17/921,505

(22) PCT Filed: Apr. 26, 2021
(86) PCT No.: PCT/AU2021/050376

§ 371 Date: Oct. 26, 2022

(30) Foreign Application Priority Data
Apr. 27, 2020 (AU) 2020202788

(51) Int. Cl. C04B 28/14; C04B 22/14; C04B 22/06; C05B 7/00; C05D 1/00; C05G 5/40; C04B 24/06; C04B 22/08; A01G 9/029; A01G 24/40

(52) U.S. Cl. CPC C04B 28/14; C04B 22/147; C04B 22/064; C05B 7/00; C05D 1/00; C05G 5/40; C04B 22/143; C04B 24/06; C04B 22/082; A01G 9/0291; A01G 24/40; C04B 2111/00758

(57) ABSTRACT

Disclosed herein are mineral-based composites that comprise gypsum, syngenite, brucite and a hydrated magnesium sulphate mineral, and which are adapted to degrade when buried. Also disclosed herein are mineral mixtures which can be used to produce the mineral-based composites, as well as products, such as plantable containers, formed from the mineral-based composites and which degrade when buried.

### TECHNICAL FIELD

The present invention relates to mineral-based composites, their methods of production and their uses. In one form, the invention relates to mineral-based composites that can be used as plantable containers for plants and which degrade when buried.

### BACKGROUND ART

Conventional agricultural containers used in plant management (e.g. in agricultural, forestry and landscaping applications, as well as for mine site tailings revegetation) are largely made from plastic materials (e.g. polymers such as high density polyethylene, polypropylene and polystyrene) or, to a lesser extent, from bioplastics, compressed fibre (e.g. wood fibre, coir and peat), concrete or metallic materials. Such materials enable the containers to have a wide variety of structural configurations and satisfy product design and packaging requirements.

More recently, however, plastic containers for plants have come under close scrutiny primarily because of their environmental impact and high life cycle costs. For example, over 90% of these plastic containers are reportedly not recycled, the bulk of which ends up either in landfills or the ocean. Some plant containers are manufactured from bioplastics or other biodegradable non-plastic materials, but many of these have been found to suffer from a number of inherent shortcomings. For example, such containers tend to lose their form stability upon continuous exposure to alternate watering and drying cycles, becoming deformed and eventually prematurely decomposing into a sludge.

Another concern with the use of both conventional plastic and degradable plant containers relates to the high cost and environmental impacts associated with excessive use of water which, in the case of nurseries or other locations where many plant containers are located in close physical proximity, can also lead to elevated concentrations of nutrients in the runoff.

The adverse environmental impacts of existing plant containers are particularly profound in large scale plantation industries such as forestry, landscaping and mine site tailings vegetation operations. Considering the massive scale of container usage in these industries, this is seen as a major threat in the face of climate change and depleting natural resources.

Regardless of such environmental cost concerns, however, many plastic-based containers continue to be used because there are no viable alternatives in terms of functionality and production cost. It would therefore be advantageous to provide containers for plants which are not formed from plastic or other potentially environmentally unfriendly materials, whilst satisfying the functional requirements of such containers.

### SUMMARY OF THE INVENTION

In a first aspect, the present invention provides a mineral-based composite comprising gypsum, syngenite, brucite and a hydrated magnesium sulphate mineral (e.g. epsomite and/or starkeyite, as described below), wherein the mineral-based composite is adapted to degrade when buried:

As will be described in further detail below, the present invention advantageously provides degradable mineral-based composites that can be formed from readily available mineral precursors under relatively benign conditions. Furthermore, the novel mineral-based composites of the invention have structural and functional properties which make them especially suitable for forming products that are strong, durable in use and which may be shaped to suit a range of applications, but which degrade when buried in the ground (e.g. at the end of their life or when planted, in the case of the plant containers described below).

The primary application of the mineral-based composites the subject of the invention which is presently contemplated by the inventors is in the agricultural industry where, as described above, reliance on plastics is causing an enormous environmental impact. In some embodiments therefore, the mineral-based composite may have a shape that defines products such as plantable containers for plants.

Further, in a second aspect, the present invention provides a plantable container for plants. The container comprises a mineral-based composite comprising gypsum, syngenite, brucite and a hydrated magnesium sulphate mineral, and is adapted to degrade when buried.

In a third aspect, the present invention provides a plantable container for plants. The container of this aspect is formed from a mineral-based composite comprising gypsum, syngenite, brucite and a hydrated magnesium sulphate mineral, and is adapted to degrade when buried.

The inventors believe that plantable containers formed in accordance with the present invention have zero landfill requirements and may achieve comparable (or superior) functionality, have reduced water and energy usages and lower product life cycle costs, when compared with conventional plant containers. The containers may also advantageously incorporate compatible recyclable materials, preventing such materials from ending up in landfill. As they degrade, the plantable containers of the present invention may also provide soil conditioning effects.

The inventors note particular applications for the invention in both domestic and commercial agriculture, for example in controlled environment agriculture (e.g. hydroponics and greenhouses), landscaping, as well as in the forestry industry and for mine site rehabilitation. As will be appreciated, however, the invention may be equally applicable outside of these industries, with the advantageous structural integrity (i.e. dimensional stability) and functionality (e.g. degradability, water holding capacity and nutrient-carrying capacity) of the inventive mineral-based composites providing significant advantages over materials presently in use.

In a fourth aspect, the present invention provides a method for producing a product that is formed from a mineral-based composite and which degrades when buried. The method comprises:
hydrating and stirring a precursor mineral mixture that comprises finely ground bassanite, magnesia and arcanite, whereby a self-binding and shapeable mineral aggregate forms;
shaping the mineral aggregate into a shape of the product; and
allowing the mineral aggregate to set, whereby the product is produced.

Advantageously, the precursor mineral mixture in the method of the present invention includes widely available mineral materials, some of which can be sourced from non-depletable resources such as seawater. The hydration and shaping steps in the method are also not necessarily energy and water intensive, as is often the case in the manufacture of conventional agricultural containers, for example. The inventors note that it is a significant advancement in the art that the products (e.g. containers) described herein can be mass manufactured without severe environmental disturbance.

In a fifth aspect, the present invention provides a mineral-based composite produced by the method of the fourth aspect of the present invention.

In a sixth aspect, the present invention provides a plantable container produced by the method of the fourth aspect of the present invention.

In a seventh aspect, the present invention provides a self-binding mineral-based composite produced by hydrating and stirring a mineral mixture comprising finely ground bassanite, magnesia and arcanite, the minerals in the stirred mixture reacting to diagenetically produce the mineral-based composite.

In an eighth aspect, the present invention provides a mixture of finely ground bassanite, magnesia and arcanite, which minerals, when mixed with water and stirred, react to form a mineral aggregate that is self-binding, shapeable and which hardens into a mineral-based composite upon setting.

Other aspects, features and advantages of the present invention will be described below.

### DETAILED DESCRIPTION OF THE INVENTION

The overarching aim of the present invention is to provide new and useful mineral-based composites which can, in some embodiments, be used to form products having superior functionality than comparable products already available. In some embodiments, for example, products formed from the mineral-based composites of the present invention may have both functional and environmental advantages, as well as being cheaper to produce, when compared with those products formed from conventional materials (especially from plastic materials).

As noted above, the present invention provides a mineral-based composite comprising gypsum, syngenite, brucite and a hydrated magnesium sulphate mineral, wherein the composite is adapted to degrade when buried. The mineral-based composite may, in some embodiments, have a shape that defines a useful product.

The present invention also provides a method for producing a product that comprises or is formed from a mineral-based composite that degrades when buried, the method comprising:
hydrating and stirring a precursor mineral mixture that comprises finely ground bassanite, magnesia and arcanite, whereby a self-binding and shapeable mineral aggregate forms;
shaping the mineral aggregate into a shape of the product; and
allowing the mineral aggregate to set, whereby the product is produced.

The mineral-based composites of the present invention (and products including or formed from the composites) may be degraded when buried via a combination of physical, chemical and biological processes in the earth, and may produce a residue that imparts conditioning effects on the surrounding medium.

The mineral-based composites of the present invention (and products including or formed from the composites) may be used in any application compatible with their structural and functional features. Given its degradability, the mineral-based composite may find particular use in applications where the product is, or ends up, in the ground, such as in agricultural industries as will be described in further detail below. However, the mouldable, self-binding and fast setting functional properties of the composite would make it useful for any number of other applications.

The products for which the mineral-based composites find particular application are as plantable containers for plants for use in both domestic settings and in agricultural industries. Accordingly, the present invention also provides plantable containers for plants that comprise or are formed from mineral-based composites comprising gypsum, syngenite, brucite and a hydrated magnesium sulphate mineral, the containers being adapted to degrade when buried.

In at least some embodiments, the present invention provides mouldable, self-binding and fast setting functional mineral composites which can be formed from precursor minerals that may be extracted from seawater or from naturally occurring mineral deposits, making its sourcing more “environmentally friendly” than other products. Also provided are mineral-based composites for use as plantable agricultural containers in an economically and environmentally sustainable manner. Compared to conventional containers, the plantable containers of the present invention may have improved form stability, strength of their structural matrix and workability, all considered highly desirable for mass-production of degradable agricultural containers.

The inventors have found that plant containers in accordance with embodiments of the present invention have a high degree of functionality, including a controllable water retention capacity for reduced water usage and nutrient runoff, as well as degradability that is effected by environmental conditions, for example upon placement into soil, earth or mine site tailings.

Furthermore, as plant containers in accordance with the present invention degrade when buried, there is no need to transplant plants contained therein when planting them in the ground. Instead, the plant and plant container can be planted, with the container degrading due to the combination of physical, chemical and biological processes once buried. This is especially advantageous because transplant shock on plants (especially on seedlings) has been known to result in high percentages of plant loss.

The mineral-based composites, and products formed from them may have any appropriate structural form. The mineral-based composites may, for example, have a porous structure. Such porosity may, for example, enable water to be retained within the structure, make lighter products or may assist in its degradation when buried. Alternatively, the mineral-based composites may have a more solid structure, with fewer internal voids. Similarly, the mineral-based composites may include agglomerates of particles, which impart a coarse-grained surface structure to the aggregate and products formed therefrom.

### Mineral-Based Composite

The mineral-based composites of the present invention comprise gypsum, syngenite, brucite and a hydrated magnesium sulphate mineral.

Gypsum (also known as calcium sulphate dihydrate—CaSO₄.2H₂O) is a hydraulically settable mineral but a weak binder. Consequently, mineral composites made from gypsum often have a “weak link” within its structural matrix. Conventional gypsum-based composites therefore need a strong binder or an external cementing agent (e.g. inorganic polymer-based fibers) in order to remedy this perceived defect. The inventors realized, however, that such a structure, supported by introduced hinders, would not be conducive to sustainable degradation of the mineral-based composite (e.g. agricultural containers formed from the composite) of the present invention upon its return to earth. The inventors have demonstrated that upon contact with soil moisture and added water, the precipitated gypsum, which forms the bulk of structural matrix in the composites of the present invention, becomes mineralogically unstable in the presence of co-existing water-soluble magnesium sulphate minerals. This phenomenon gives way to increasing form instability of the composite's structural matrix, and the eventual disintegration of the composite (and hence products formed from or including the composite) by a combination of physical, chemical and biological processes, as described in further detail below.

As described below, the crystallization of gypsum from a suspension of calcium sulphate hemihydrate occurs in the second stage of hydration of bassanite, wherein the formation of bassanite submicron rods is followed by self-assembly of these rods along the c-axis, leading to formation of gypsum microcrystals. This process of formation of gypsum via bassanite sub-micron rods proceeds without the need for any additive.

In the present invention, gypsum formed from rehydration of the bassanite in the precursor mineral mixture forms the bulking agent and develops a strong link with the co-precipitating diagenetic syngenite and brucite binders within the composite's structural matrix. This enables the formed mineral aggregate to set relatively quickly, and also expedites the evaporative dehydration process, collectively resulting in the formation of a relatively strong mineral composite, over a relatively short span of time.

Furthermore, when degraded (i.e. after the composite is buried), gypsum is a source of sulphur, which is a key component of certain essential amino acids that are the building blocks for proteins, as well as a principal element for chlorophyll synthesis. Many soils are now deficient in sulphur, which can result in the leaves of plants grown in the soil yellowing and cupping, as well as in flowers being smaller and paler. Gypsum is also a source of calcium, which is an essential element that plays an important role in nutrient uptake. Without adequate calcium, nutrient uptake and root development of plants slows. Calcium is also essential for many plant functions including cell division, soil wall development, nitrate uptake and metabolism, enzyme activity and starch metabolism.

Gypsum is the major component of the mineral-based composites of the present invention. The amount of gypsum in the composite may, for example be at or above about 30%, at or above about 35%, at or above about 40%, at or above about 45%, at or above about 50%, at or above about 55%, at or above about 60%, at or above about 65%, at or above about 70%, at or above about 75% or at or above about 80% of the total mineral-based composite (w/w).

Syngenite (CaSO₄.K₂SO₄.H₂O) is a fast setting double-sulphate mineral that is formed diagenetically according to the reactions described below. Syngenite is the dominant binding agent in the self-binding composites of the present invention.

Syngenite gives form stability to the mineral aggregates and composites of the present invention, regardless of the extent of hydration or curing that has taken place. Syngenite can precipitate within mineral aggregates having arcanite contents as low as 0.5% w/w equivalent of total weight of dry aggregate (w/w). However, as the presence of less hydraulic binder will make the resultant mineral-based composite more soluble in water, the amount of arcanite additive can be adjusted according to the teachings of this invention in order to provide the desired stability versus degradability design requirements of the composite and products formed therefrom (e.g. plantable agricultural containers).

Syngenite is also a low bulk density slow-release secondary potassium fertiliser which may be used to neutralise a soil's sensitive to chlorinity/salinity, improve the soil's pulping characteristics and reduce runoff erosion.

Syngenite is a moderate component of the mineral-based composites of the present invention. The amount of syngenite in the composite may, for example be between about 10 and about 30% (w/w) of the total mineral-based composite. In some embodiments, for example, the amount of syngenite in the composite may, for example be between about 15 and about 25% (w/w), between about 10 and about 20% (w/w), between about 15 and about 30% (w/w) or between about 20 and about 30% (w/w) of the total mineral-based composite. In some embodiments, the mineral-based composite may comprise about 10%, about 15%, about 20%, about 25% or about 30% (w/w) syngenite.

Brucite (also known as magnesium hydroxide—Mg(OH)₂) is a secondary hydraulically settable binding agent in the composites of present invention and is also precipitated according to the reactions described below. Like syngenite, brucite is produced diagenetically through the reaction of materials in the precursor mineral mixture in water under agitating conditions using a high shear mixer. Brucite is nearly insoluble in water and, in addition to its binding and form stability effects, it can provide a number of benefits to products such as plantable agricultural containers made from the mineral-based composites of the present invention. For example, brucite adjusts the pH of the mineral aggregate prior to form setting, which is beneficial when additives requiring an alkaline environment are present, and often desirable in mass manufacture of products such as plantable agricultural containers using compression and injection moulding techniques.

Other benefits of brucite relevant to agricultural applications of the invention include a pH adjustment of the soil and water in contact with the container, providing favourable plant growth environment (particularly in the case of containers with high water retention capacity), and soil conditioning properties of the containers inserted in soil or disposed in landfill, particularly in the case of soils or landfill material having high acidity.

Brucite is a minor component of the mineral-based composites of the present invention. The amount of brucite in the composite may, for example be between about 2 and about 10% (w/w) of the total mineral-based composite. In some embodiments, for example, the amount of brucite in the composite may, for example be between about 2 and about 7% (w/w), between about 2 and about 5% (w/w), between about 5 and about 10% (w/w) or between about 7 and about 10% (w/w) of the total mineral-based composite. In some embodiments, the mineral-based composite may comprise about 2%, about 4%, about 6%, about 8% or about 10% (w/w) brucite.

Hydrated magnesium sulphate minerals have the chemical formula MgSO₄.nH₂O, where n can be from 1 to 7. Magnesium sulphate may be obtained from natural sources, and is also produced increasingly from a variety of industrial processes. Magnesium sulphate, commonly in the form of starkeyite (MgSO₄.4H₂O) and/or epsomite (MgSO₄.7H₂O) represents a minor component of the mineral-based composites of the present invention, and forms diagenetically in the mineral agglomerates of the present invention according to the reactions described below. The magnesium sulphate mineral type in the composite depends on the state of hydration of the mineral following curing. Being highly water soluble, the roles of magnesium sulphate in the composites of the present invention are twofold, namely (a) dissolution in soil environment, thereby facilitating the disintegration of the composite/product over time, and (b) providing nutritious effects on the surrounding soils.

Hydrated magnesium sulphate minerals are also a minor component of the mineral-based composites of the present invention. The amount of these minerals in the composites maybe as described above in relation to brucite.

### Precursor Mineral Mixture

The precursor mineral mixture used to produce the intermediate mineral aggregate and subsequently the mineral-based composites (and products formed therefrom or thereof) comprises finely ground bassanite (also known as calcium sulphate hemihydrate—CaSO₄.½H₂O), magnesia (MgO) and arcanite (K₂SO₄).

As will be described in further detail below, when the precursor mineral mixture is mixed with water, a self-binding and mouldable mineral aggregate is formed, in which the bulk of particles have no orientation or alignment in the direction of the flow of material during the moulding process. The mineral aggregate may also be relatively fast setting, especially in embodiments where setting is accelerated (described below).

Bassanite is the main constituent of the precursor mineral mixture. Bassanite is prepared cither by calcination of gypsum mineral using conventional calcination or flash calcination processes. Gypsum may be obtained from a number of sources including naturally occurring gypsum deposits, and a number of synthetic gypsum varieties including phosphogypsum byproduct from phosphoric acid production processes, gypsum produced by calcination of recycled gyprock, gypsum recovered from seawater brines and bitterns and gypsum byproduct from flue gas desulfurisation processes.

A commercially available combined calciner-grinder apparatus is the preferred means for producing a homogenous, finely ground bassanite feedstock. Particle size of finely ground bassanite in the mineral mixtures can be in the range of 0.05 mm and 2 mm across, and fineness (D_{95%}) preferably in the range of 0.1 mm and 0.5 mm across.

The majority of conventional technical approaches for using bassanite to manufacture gypsum-based products are based on direct conversion of traditional bassanite produced in conventional calcination processes to gypsum via a single-stage hydration process. However, it has now been demonstrated that, when reacted with water at low temperatures, bassanite mineral, regardless of its method of production, does not transform directly to gypsum mineral by a single-stage hydration process. In fact, it has been found that gypsum mineral forms in the second stage of the hydration of the bassanite mineral.

Accordingly, the finely ground bassanite, being a relatively soluble mineral, when reacted with water at room temperatures, produces a supersaturated solution in which, depending on the presence and ionic strength of other dissolved elements, calcium and sulphate ions can remain in solution for tens of minutes prior to the rearrangement of the bassanite sub-micron rods along the c-axis to form gypsum microcrystals. During this residence time, various reactions can take place and consequentially different mineral agglomerates can be formed. It has further been demonstrated that the residence time of the dissolved ions of calcium and sulphate, obtained from the mixing of finely ground bassanite with water at room temperature, can be further extended by addition of weak acids and their derivatives as retarding agents (discussed below). These properties of staged hydration of bassanite are advantageously used in the present invention to produce mouldable self-binding composites, further described below.

The amount of bassanite in the precursor mineral mixture may be any amount effective to produce the mineral-based composites described herein. The bassanite may, in some embodiments, be 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97% or 97.5% relative to dry weight of mineral mixture or other incremental percentage between.

Magnesia is highly reactive with water and is widely used as a flux in mineral processing absorbent in water, wastewater and odour control processes. Magnesia can advantageously be sourced from replenishable seawater by decomposing Mg(OH)₂ recovered from seawater brines and bitterns. Magnesia may also be produced from calcination of naturally occurring magnesite and dolomite ores as well magnesium rich by-products of processing of carbonate minerals in many parts of the world.

The amount of magnesia in the precursor mixture may be any amount effective to produce the mineral-based composites described herein. The magnesia may, in some embodiments, be 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% relative to dry weight of mineral mixture or other incremental percentage between.

Arcanite (a potassium sulfate mineral with formula K₂SO₄) is a premium-quality potash fertilizer salt currently largely produced in a method commonly known as the Manheim Process, which involves the reaction of potassium chloride (KCl) salt (as the source of potassium ions) with sulphuric acid (as the source of sulphate ions). A significantly lesser tonnage of potassium sulphate (also known as sulphate of potash, or SOP) is produced by mineral conversion (commonly known as secondary processes) which involves the reaction of KCl salt with naturally occurring minerals of sodium sulphate or magnesium sulphate (both minerals as sulphate ion donors).

Arcanite is used for cultivating high-value crops like fruits, vegetables, nuts, tea, coffee and tobacco, which are sensitive to chloride content in soil. The use of SOP improves quality and crop yields and makes plants more resilient to drought, frost, insects and even disease, as well as improving the look and taste of foods. It also improves a plant's ability to absorb essential nutrients like phosphorus and iron.

The amount of arcanite in the precursor mineral mixture may be any amount effective to produce the mineral-based composites described herein. The potassium sulphate may, in some embodiments, be 0.5%, 1%, 2%, 3%, 4%, 5%, 6%, 7%, 8%, 9%, 10%, 11%, 12%, 13%, 14%, 15%, 16%, 17%, 18%, 19% or 20% relative to dry weight of mineral mixture or other incremental percentage between.

The precursor mineral mixture includes finely ground bassanite, magnesia and arcanite. As used herein, “finely ground” is to be understood as meaning that the particle size of finely ground individual constituents of the precursor mineral mixtures is in the range of 0.01 mm and 2 mm across, preferably 0.05 mm and 2 mm across, and fineness (D_{95%}) preferably in the range of 0.1 mm and 0.5 mm across. A commercially available combined calciner-grinder apparatus is the preferred means for producing homogenous, finely ground feedstocks for the precursor mineral mixture.

Such a particle size can: (a) increase particle packing density and reaction rate by increasing the surface areas of the particles for the production of self-binding, fast setting and mouldable aggregates via direct chemical reactions and diagenetic processes which can include ion release and exchange, mineral dissolution/precipitation, incipient crystallisation and mineral phase change, (b) increase the textural homogeneity (distribution of porosity and permeability) of the structural matrix, (c) control the amount of water used for preparing mouldable and workable mineral aggregates, and (d) optimise the microstructural engineering design criteria for mass production of plantable agricultural containers having set water retention capacities.

### Further (Optional) Additives

The mineral-based composite of the present invention may optionally include additives in addition to gypsum, syngenite, brucite and a hydrated magnesium sulphate material, where such additives do not deleteriously affect the formation and functionality of the intermediate mineral aggregate and the composite/products made therefrom. Examples of further additives, the inclusion of which may provide advantageous structural/functional properties or cost efficiencies to the mineral-based composites and products made therefrom, will be described below.

### Monoammonium Phosphate

In some embodiments, monoammonium phosphate (MAP) may be added to the precursor mineral mixture or may otherwise be incorporated into the mineral-based composite. MAP is a non-toxic highly water-soluble substance, having a chemical formula of NH₆PO₄ and is used as a source of P and N nutrients in many agricultural fertilisers. Including a relatively small amount of MAP with the precursor mixture can therefore result in the manufacture of degradable agricultural containers having even further nutritive effects on the recipient soils. Rapid mixing of a relatively small amount of MAP with the precursor mixture results in the formation of mineral struvite (NH₄MgPO₄.6H₂O) as a trace mineral component of the mineral-based composites of the present invention.

The mass ratio of MAP to total mineral mixture is dependent on the mass ratio of arcanite to total weight of mineral mixture and can range from 0.1% to 5% relative to total weight of mineral mixture (w/w) and preferably from 0.5% to 3%, relative to total weight of mineral mixture (w/w).

In some embodiments, the precursor mineral mixture may further comprise discrete fertiliser pellets distributed therethrough, whereby the resultant mineral-based composite further comprises the discrete fertiliser pellets distributed therethrough. The fertiliser pellets may, for example, comprise monoammonium phosphate and arcanite.

The mineral aggregates may, for example, be prepared including nutritive pellets (hereafter named as “N-P-K pellets”) comprised of a predetermined mixture of mono ammonium phosphate (MAP) and arcanite. The N-P-K pellets may, for example, be cylindrical, spherical or other shape. The size of spherical or substantially spherical pellets can range from about 0.2 mm to 20 mm across.

Production of the N-P-K pellets may be performed, for example, by using a conventional pelletiser apparatus such as a rotating bottle or a tumbler. Microscopic examination reveals that such N-P-K pellets are comprised of a nucleus containing unreacted MAP and arcanite minerals surrounded by a rim including acicular crystals of syngenite that are perpendicularly oriented with respect to the surface of each pellet. The curing time of the N-P-K pellets is within the range of 5 minutes to 10 minutes, depending on the mass ratio of the mineral mixture to total amount of MAP and arcanite and to a lesser extent the volume of material in the tumbler, mixing speed, and humidity of material in the tumbler. Based on experimentation using various ratios of mineral mixture to total amount of MAP and arcanite, ratios between 2:1 and 1:1 typically provide favourable operating conditions and curing time.

The pellets may be used as an additive to the precursor mineral mixtures prior to adding the water to produce the mineral aggregates according to the invention. The composites containing the N-P-K pellets are particularly suitable for manufacture of degradable agricultural containers aimed at soils having deficiencies in N-P-K nutrients, whilst also assisting the degradation process of the containers because of faster dissolution of the pellets and hence the development of secondary permeability zones in the containers' walls.

### Inorganic Fillers

In some embodiments, the precursor mineral mixture may also include one or more inorganic fillers, whereby the resultant mineral-based composite further comprises the inorganic filler(s). Inorganic fillers may include any mineral type, ranging from gravel to clay particle size which are also generally inexpensive and can be procured easily in dry form, in any quantity from many suppliers. Preference is given to fillers having minimum or no adherence to the moulding apparatus and thus minimising the need for mould releasing agents.

Contemplated inorganic fillers include quartzose sand, gravel, perlite, vermiculite, pumice and zeolites. Addition of inorganic fillers enables the rheological behaviour, workability and reinforcement of the mixture and setting aggregate to be controlled, improved, or otherwise adjusted. The use of inorganic fillers can therefore enable the microengineering design of agricultural containers in terms of physical strength, product weight, density, brittleness, printability, water retention capacity, nutrient runoff from the planted containers as well as final appearance, costing and degradability features of the containers. Such engineering enables the functionality of containers to be finely tuned for specific market applications.

Quartzose sand and its varieties include silica sand, glass, crushed quartz stone, amorphous silica, chalcedony, jasper, chert, flint and their coloured varieties are suitable fillers for use in the present invention for the purposes of increasing density and strength, with the finer particle size varieties preferred for also improving the workability of the aggregates/composites for mass manufacturing. The amount of quartzose sand added to mineral mixture can vary from 1% to 10% relative to total weight of mineral mixture (w/w), and preferably in the range of 3% and 7% dry weight.

Gravel of any mineralogical composition, provided it is washed first, can be used with the amount corresponding to that of quartzose. Sand and crushed to coarse sand size preferred.

Because of inertness and inherent physical features (e.g. low mass, large air holding capacity and ease of handling), perlite may advantageously be used to adjust the weight and water retention capacity of the mineral aggregate/plantable agricultural containers of the present invention. Perlite aggregates of various particle sizes can be directly added to the precursor mineral mixtures before adding water and transfer of the mineral aggregate to an appropriate moulding apparatus for setting. Alternatively, prior to transfer to moulding system the mineral aggregate containing a predetermined amount of a particular sized perlite can be further treated by the methods of aeration, agglomeration and seeding, according to the following embodiments of this invention, with the objective of optimising the density of the structural matrix while increasing the water retention capacity as well as adjusting the degradability of the containers for return to earth.

Vermiculite has similar properties and applications to perlite but, in general, holds less air and more water and is less buoyant, making it a particularly suitable co-filler with fine particle size perlite for the manufacture of products in the form of hydroponic containers requiring controlled water-retention capacity. Like perlite, pumice is another lightweight mineral of volcanic origin which may be used as a substitute for perlite, particularly for the manufacture of hydroponic containers.

Where the weight of containers of present invention is less relevant, zeolite may be used as an alternative inorganic filler for providing additional properties to the containers, notably improved water and nutrient absorption capacities.

In some embodiments the mineral aggregates may be prepared from precursor mixtures that include one or more inorganic fillers. Individually, the amount of each inorganic filler can vary from 1% to 10% relative to total weight of mineral mixture (w/w), and preferably in the range of 3% and 7% dry weight. Depending on container applications, the total amount of perlite, vermiculate and pumice added individually or collectively to the mineral mixture can vary from 3% to as much as 50% relative to total weight of mineral mixture (w/w), and preferably in the range of 5% and 10% dry weight for compositions produced for containers earmarked for non-hydroponic applications.

### Organic Fibres

In some embodiments, the precursor mineral mixture may also include one or more organic fibres, whereby the resultant mineral-based composite further comprises the organic fibres. Such organic fibres provide reinforcement and weight reduction to the composite (and products formed therefrom), whilst increasing the water retention capacity and adjusting the degradability features upon return to earth. The nature and amount of organic fibre can also affect the rheology and workability of the mouldable aggregates, as well as the properties of the final hardened product, such as insulation and printability and thus the manufacturing costs.

Apart from the importance to manufacturing practice, the type and amount of fibre species used in containers of the present invention will have a direct influence on the manner and rate of physical degradability of the composites upon their return to earth, due to alternate expansion and contraction of the fibres when exposed to successive wetting and drying events in the soil profile. Based on foregoing, the optimum amount of organic fibres to be added to the mineral mixtures of the present invention shall be determined after trials conducted by a person skilled in the field in order to accommodate variation in the type of fibre species with particular attention given to their specific gravity.

The organic fibres can be selected from biodegradable fibers (such as those available in the form of saw cuttings and wood shavings), hard woods, softwoods, as well as naturally occurring organic fibers extracted from hemp, flax, sisal, jute, kenaf, coir, cotton, plant leaves or stems such as pineapple leaves, any vegetal natural composites consisting of cellulose fibrils bounded in a matrix of hemicelluloses and lignin, etc. Typically, the fibres would have an aspect ratio of about 50:1 to about 5:1 and more preferably about 10:1, with the individual fibres having lengths less than about 5 mm and preferably less than 3 mm.

The organic fibers may be added to the mineral mixtures in amounts suitable for achieving a suitable degradability function of the resultant composite, as well as to enhance its water retention capacity. Generally, the fibers can be added in amounts of between about 3% and 10% relative to total weight of mineral mixture (w/w), more preferably less than about 5% by dry weight.

### Pesticides

In some embodiments, a pesticide may be added to the precursor mineral mixture or mineral aggregate. Suitable pesticides may include insecticides, herbicide, bactericides, fungicides, rodenticides and larvicides. The function of the pesticide is to protect plants contained in containers formed from the mineral composite of the present invention from pests such as insects and microorganisms. The pesticide(s) may be provided in the form of powder, agglomerates/pellets, capsules, etc. The selection of pesticides will depend on pesticide efficacy as determined by comparing benefits against the optimum amount of pesticide used to minimise potential environmental risks.

Generally, pesticides consist of several substances, including one or more active ingredients mixed with other accompanying compounds to stabilize the active agents and to enhance its controlled release or provide a synergistic effects between two insecticides or with an insecticide and a fertiliser regime. Accordingly, the pesticides in the products/containers of the present invention will vary from one application to another.

Hormones or growth promotants made in the form of powder, agglomerates/pellets and capsules can also be included in the mineral mixtures of the present invention.

In one embodiment, for example, a predetermined amount of finely ground pesticide may be added to the precursor mixture and thoroughly mixed prior to further treatment according to the present invention. As some pesticides are poorly water soluble, to increase solubility it can be micronised, optionally to nano-particle size, prior to mixing with above mentioned mineral mixtures.

In another embodiment, a predetermined amount of finely ground pesticide may be agglomerated using a dry mix of the finely ground mineral mixture, and thoroughly mixed in an appropriate mixing vessel prior to agglomeration according to the steps described herein. Optionally, the micronised pesticide ingredient can be directly mixed thoroughly with the MAP and arcanite powders described above to produce N-P-K pellets empowered with pesticides for point source controlled release, which is highly desirable in remotely located large-scale plantations including but not limited to forestry, landscaping and mine site tailings vegetation operations.

The inventors note that agricultural containers including one or more pesticide compounds provide alternatives to existing methods and practices. For example, the inventors hope that this invention may help in reducing the impact of modern agriculture on the environment and human health and contribute to global food security. For example, agricultural containers of the present invention may have fungicides included in the body of the containers (either in the mineral mixture or as discrete pellets), which reduces the need to applying fungicides to soils containing plants cultivated in the said containers, particularly for use in controlled environment agriculture (CEA).

### Colourants/Coating Agents

In some embodiments, the mineral aggregate may further comprise a colourant. Such substances may be used to provide colouration, surface sealing, water proofing, smoothening, glossiness and other desirable surface textural effects and visual appearance to final products.

Any suitable colourant may be used. The colourant may, for example, be selected from degradable mineral oxides (e.g. iron, aluminium and silicon oxides), distress oxides, mica powder, Indigo, food colourants, tea colourants, latex, metallic copper, chalk blue, henna, etc.

The colourant(s) may be applied before, during, or after the moulding process in order to colour the resultant mineral-based composite (e.g. agricultural container). In some embodiments the mineral aggregates may be prepared from precursor mixtures that include one or more colouring agents/courants. Generally, one or more finely ground colouring agents can be added directly to the precursor mineral mixture and subjected to high shear mixing before transfer to a mould for form setting and curing. The colouring agents can be also applied in a solution form after the de-moulding and curing of the aggregate, if it is desired to make the container surface (or a part thereof) more waterproof or to give it a desirable surface texture (e.g. glossiness) for the purposes of printing, engraving or embossing.

Typically, the colourant would be added directly to the mineral mixtures of the present invention with water and the resultant mineral aggregate mixed thoroughly under high shear mixing conditions. For example, a solution of finely powdered colouring agent can be prepared by dissolving it in cold water at room temperature, and adjusting the balance of water added to dry mineral mixture and the resultant mineral aggregate mixed thoroughly under high shear mixing conditions.

As the mineral aggregates of the present invention are generally fast setting and have a high porosity, the applied colourant would tend to dry rapidly. In embodiments where powdered pigments of metal oxide are used, they can be dissolved first in water in order to enable rapid metal oxidisation to their respective higher and more stable valencies for the purpose of smooth body colouring of the containers.

In some embodiments, a coating agent may be applied to the mineral-based composite. The coating agents can be selected from degradable resins and rosins including but not limited to shellac, camphor, colophony rosin, gum copal, starch based adhesives, etc, Coating agents may be used to provide a desirable surface textural effect, such as colouration, sealing, smoothening, glossiness or a combination thereof.

Generally, the coating agents are used for either containers earmarked as floral or ornamental containers or decorative agricultural containers and applied after adequate curing so as to also improve the functionality of the said containers. However the aforementioned coating agents can also provide additional functions such as increasing water retention capacity, sealing, water proofing while giving colouring and desired designer patterns. In the case of agricultural containers, shellac, being a natural bioadhesive polymer, is particularly a preferred coating agent because of its thermoplasticity under heat and pressure conditions as well as fast drying, high durability, glossiness and hardness.

One skilled in the art will be able to determine the type and amount of colourant or coating agent to be added to the precursor mineral mixture or applied directly to moulded and cured products/containers from assessing the surface porosity, adequacy for desired colouring or coating effects and compatibility of the agents with respect to labelling/engraving requirements of the final product.

Optionally, the surface of the product/container can be first thinly coated or sprayed with a 5-10% starch solution concentrate in order to seal the surface pores of the dried container prior to application of the colouring agent (in either solution or pigment form). The application rate of the colourant will therefore vary but, generally speaking, a finely powdered colourant having a concentration of less than about 0.5% relative to total weight of mineral mixture (w/w) and more preferably less than about 0.2% by dry weight would be suitable.

Method for Producing a Product from a Mineral-Based Composite

The method for producing products that are formed from mineral-based composites which degrade when buried will now be described. The method of the present invention comprises:
hydrating and stirring a precursor mineral mixture that comprises finely ground bassanite, magnesia and arcanite, whereby a self-binding and shapeable mineral aggregate forms;
shaping the mineral aggregate into a shape of the product; and
allowing the mineral aggregate to set, whereby the product is produced.

Each of these steps will be described in turn below.

Hydrating and Stirring a Precursor Mineral Mixture that Comprises Finely Ground Bassanite, Magnesia and Arcanite, Whereby a Self-Binding and Shapeable Mineral Aggregate Forms

In a first step, the precursor mineral mixture described above, optionally including one or more of the additives described above, is hydrated and stirred, preferably at room temperature and in a high shear solid-liquid mixer in order to hydrate, dissolve, wet and disperse the constituents. The components in the resultant mineral aggregate slurry can react to diagenetically form and harden into the mineral-based composites of the present invention.

As described above, a staged hydration process of bassanite forms the basis of the present invention, with the predetermined quantities of finely ground minerals of bassanite (as the donor of calcium and sulphate ions), magnesia (as the donor of magnesium ions) and arcanite (as the donor of potassium ions) being provided in intimate mixture. The precursor mineral mixture is stirred, preferably in a high shear mixing apparatus, with a predetermined amount of water at room temperature to produce a shapeable (e.g. mouldable) mineral aggregate that include the minerals gypsum (as a bulking ingredient), syngenite and brucite (as binding agents), and a hydrated magnesium sulphate mineral as a minor (nutritious) mineral component.

Laboratory observations supported by petrographic information point to syngenite as the dominant fast-setting binder, which is disseminated throughout the structural matrix, making the intermediate mineral aggregates of the present invention self-binding and highly settable for use in the mass manufacture of products (such as degradable agricultural containers, for example). The process reactions leading to formation of the functional mineral-based composites of the present invention are as follows:

[Individual Reactions]

CaSO₄.½H₂O+K₂SO₄+½H₂O→CaSO₄.K₂SO₄.H₂O (syngenite) [1]

CaSO₄.½H₂O+3½H₂O→CaSO₄.2H₂O (gypsum) [2]

MgO+H₂O→Mg(OH)₂ (magnesium hydroxide) [3]

MgO+CaSO₄.½H₂O+nH₂O→MgSO₄.nH₂O+CaSO₄.2H₂O [4]

[Summary Reaction]

CaSO₄.½H₂O+K₂SO₄+MgO+nH₂O→CaSO₄.2H₂O+CaSO₄.K₂SO₄.H₂O+Mg(OH)₂+MgSO₄.nH₂O [5]

The number (“n” value) of water molecules in the hydrated magnesium sulphate mineral formed according to above-listed reactions depends on the hydration status of the mineral magnesium sulphate upon drying of the product manufactured from the composites of the present invention. The “n” value can range between 1 and 7 with starkeyite (n=4) and epsomite (n=7) identified as the most common mineral types of magnesium sulphate salt.

As is described in detail above, in some embodiments of the method of the present invention, the precursor mineral mixture may comprise between about 30% w/w and about 97.5% w/w of bassanite (by weight of dry mixture).

As is described in detail above, in some embodiments of the method of the present invention, the precursor mineral mixture may comprise between about 2% w/w and about 50% w/w of magnesia (by weight of dry mixture).

As is described in detail above, in some embodiments of the method of the present invention, the precursor mineral mixture may comprise between about 0.5% w/w and about 20% w/w of arcanite (by weight of dry mixture).

As is described in detail above, in some embodiments of the method of the present invention, the finely ground bassanite, magnesia and arcanite may each independently have a particle size of between about 0.05 mm and about 2 mm.

In the present invention, the mixing and reaction temperature can advantageously be performed at room temperature, i.e., within the range of about 12° C. and about 35° C. and preferably within the range of about 18° C. and about 25° C. The inventors note that such conditions promote an accelerated precipitation of diagenetic syngenite mineral as a stable binder within the body of mineral aggregates using a high shear mixer, thus providing the advantageous effects described herein.

Typically, the precursor mineral mixture is hydrated with water that has been adjusted to room temperature. The amount of water will depend on the type of bassanite used in the precursor mixture, as well as the amounts and ratios of various constituents of the precursor mineral mixture, noting that this may optionally include additives such as mineral fillers, organic fibres, colouring and coating agents, seeding agents and retardants. The amount of water used can, for example, be 10%, 20%, 30%, 40%, 50% or 60% relative to dry weight of mineral mixture or other incremental percentage between.

In general, if the amount of water to be added to the dry precursor mineral mixture is in excess of the theoretical amount of water required, this will decrease the viscosity (and hence increase flowability) and increase the setting time of the mineral aggregates. Additionally, depending on the amount of excess water added, the form stability of the moulded product may decrease. Excess water addition will also require longer hardening time for its removal by evaporative dehydration, unless hardening is obtained by artificial heating (which is costly).

Accordingly, the amount of water added to various dry precursor mineral mixtures, optionally having additives as described above, can be highly variable over a wide range, particularly when different methods for production of the composites (e.g. conventional mixing, seeding, agglomeration, aeration, etc., as described below) are employed. By way of example, the amount of water in a mineral-based composite containing no additives, and produced by conventional mixing methods, can range from about 10% relative to total weight of dry mineral mixture to about 60% by dry weight, more preferably from about 45% by dry weight to about 55%, dry weight and most preferably from about 48% dry weight to about 52% by dry weight. By way of example, the amount of water used with precursor mineral mixtures including mineral fillers (e.g. sand or fine perlite) preferably ranges from about 40.5% by dry weight to about 52% by dry weight. By way of example, the amount of water used with precursor mineral mixtures including organic fibre as the sole filler (e.g. untreated fine sawdust or wood shavings) preferably ranges from about 50.5% relative to total weight of dry aggregate (w/w) to about 60% by dry weight.

In embodiments where agglomerated and cellular mineral-based composites (described below) are formed, using any of the seeding agents disclosed herein (also described below), the total amount of water needed for producing mouldable mineral aggregates and composites/products with adequate structural integrity and strength will generally be less than the amount of water that would be required for producing mineral aggregates using the method described above. In such instances, less water is needed, due to accelerated internal drying from fast chemical reaction of the sulphatic seed material with water, as well as the reduced availability of water to be absorbed on the walls of interparticle pores and the permeability zone. In such cases, the amount of water required is substantially lower, ranging from about 10% relative to total weight of dry aggregate to about 40.5% by dry weight, and more preferably ranging from about 20% dry weight to about 31% dry weight.

The inventors note the free water, that is the moisture absorbed on the walls of porc spaces and permeability zones in the walls of hardened containers by a combination of surface tension of water and capillary action, can be less than 5% by wet volume relative to total volume of dry aggregate, more preferably less than about 3% by wet volume. Additional free water is generally present in composites that include organic fibers, and hardened containers having such free water provide complimentary benefits in the context of plantable agricultural containers, which are capable of sustaining a more hydrated environment within the container than would otherwise be possible. This is particularly advantageous for containers with high water retention capacity, earmarked for remotely located cultivation, such as forestry and mine tailings revegetation.

As noted above, in some embodiments, it may be desirable to use an excess amount of water, relative to overall weight of the precursor mineral mixture, to provide additional workability during the shaping/moulding processes, which excess water can in turn be removed by heating up to 60° C. after removal of the form set product from the mould, for example as part of the hardening process. This situation particularly applies to embodiments of the precursor mineral mixture that contain water absorbing additives, such as organic fibres or coarse grain mineral fillers. Zeolites, having more pore space, also provide adequate rheological properties and workability, comparable to that of aggregates that are devoid of such additives.

In embodiments where water soluble additives (such as mineral pigments) are to be included in the mineral aggregates, water would usually first be used to dissolve the pigment. A predetermined amount of water, additional to the pigment solution, would then be added to the dry mineral mixture, together with the pigment solution and thoroughly mixed.

In light of the guidance provided above, a person skilled in the art would be able to determine, using no more than routine trials, an amount of water required for producing mineral aggregates with adequate rheological properties and workability, for any given precursor mineral mixture and desired product. As a general rule, using a minimum amount of water will reduce the need for evaporative dehydration by subsequent heating, consequentially reducing the cost of manufacturing. Nevertheless, the composites of the present invention include far less water, even less than the upper ranges of water inclusion, compared to slurries used to make paper products, which generally contain more than 95% water by volume.

### Seeding Agent

In some embodiments, the method may further comprise adding a seeding agent during stirring of the forming mineral aggregate in order to promote formation of the mineral-based composite and change (usually lessen) the time it takes to produce a form-stable product, without compromising its structural integrity or degradability. Suitable seeding agents may, for example, be finely ground bassanite or arcanite.

The use of a seeding agent can also provide additional manufacturing advantages, such as providing special surface textural effects (i.e., graininess and colour shading) and enhanced printability while generating products that do not adhere to the moulds.

As elaborated in the embodiments described below, such seeding can also provide additional benefits when used in conjunction with either agglomeration or aeration processes to manufacture products having granular or cellular texture (e.g. plantable agricultural containers having a high water retention capacity and tubes for forestry and mine site tailings revegetation which are generally remotely located and a reduced watering regime is highly beneficial). Seeding can also help to avoid the bubble coalescence and consequentially the collapse of micro- and macropores generated by the aeration and/or agglomeration processes (described below). The collapse of macropores is particularly a major shortcoming in the manufacture of cellular and foamed agricultural articles produced according to prior art, where substantial amounts of surfactants are used to remedy this shortcoming.

Generally, the seeding agent can be added in amounts of up to about 5% (w/w) relative to total weight of the (dry) precursor mineral mixture, more preferably less than about 3% by dry weight, and even more preferably, less than about 2% by dry weight.

### Aeration

In some embodiments of the method, air may be blown into the mineral aggregate during stirring, whereby a porosity of the produced composite/product is increased. In such embodiments, the mineral-based composites, and products formed therefrom, tend to have a cellular texture. The cellular products produced by a method including such an aeration process are substantially lighter than their non-aerated counterparts, with weights typically being 20% to 50% lighter. The amount of water required to produce cellular products is also substantially lower than their non-aerated counterparts, with water usage typically being 35% to 75% less than corresponding non-aerated containers. Furthermore, the resultant products tend to harden in a significantly shorter time than the non-aerated versions, with hardening time of the aerated products ranging between 30 and 90 minutes. Both weight and water usage efficiencies are controllable as they are directly dependent on method of aeration and wall thickness of the containers.

Any suitable technique may be used to aerate the mixture. For example, the forming mineral aggregate may be aerated using an appropriate aeration apparatus prior to its transfer to a moulding apparatus. The cellular texture may, for example, be generated in the mineral aggregate itself before the moulding stage, by means of introducing air voids, preferably by using a high shear, high speed mixing vessel while blowing air into the vessel.

Incorporating air voids within the structural matrix of products, without compromising their strength, is a highly desirable feature in the mass manufacturing of products such as agricultural containers. Such a structure provides an increased water retention capacity and reduced weight, whilst achieving substantial efficiencies in labour and energy costs. Such cellular containers have demonstrably wide ranging applications, particularly in the exponentially growing field of controlled environment agriculture where continuity of air circulation through the walls of the containers can avoid moisture build-up on and around the leaves, thus reducing incidence of parasites and/or leaf rot; with increased air circulation the leaves can also transpire more efficiently which further prevents necrosis. Additionally, the combination of cellular wall texture and mildly alkaline nature of the composites (due to presence of magnesium hydroxide) prohibits algal growth which is an issue of concern for consumers of containers of existing art.

Advantageously, apart from minor use of a foaming agent (such as an emulsifier or detergent) in some embodiments, and contrary to existing methods and practices, no stabilising agents, pH adjustment. C02 gas injection, heating during moulding, etc., are required in the present invention to aid the incorporation and retention of air voids. Furthermore, oxidized metal mixtures are also not required to adjust the viscosity of the aerated composites to enable retention of the pores during the moulding process, as is the case in many conventional aeration techniques. Furthermore, being self binding, no additional hydraulic binder is required to support form stability of the cellular products of the present invention.

When the method involves a combination of aeration and seeding processes, the amount of selected seeding agent can vary within the range from about 2% to about 10% (w/w) relative to total weight of the precursor mineral mixture and preferably within the range from about 3% to about 8% by dry weight. For economic manufacture of thin walled containers, such as high water retention capacity seeding cubes or hydroponic pots and trays, a combination of aeration and seeding processes is preferred, wherein a higher amount of seeding agent, in the range of 10% to about 15% (w/w) relative to total weight of the mineral mixture can be added. Alternatively, the manufacture of light-weight thin walled cellular products can be achieved without seeding by adding a predetermined amount of a lightweight mineral filler, such as ground perlite. The latter method provides a marginally higher density structural matrix while correspondingly lowering the energy and labour costs associated with mass manufacturing of thin walled cellular containers.

### Retarding Agent

In some embodiments of the method, a retarding agent effective to slow curing/setting time may be added during stirring. Preparing the mineral aggregates in the presence of a retarding agent extends the setting time of the composites in order to improve the workability of the mineral aggregates for moulding (but without compromising the structural integrity and functionality of the manufactured products/containers). Retarding agents may also provide additional benefits such as improved fluidity, pH stability and anti-sag performance during the manufacture of the composites.

Without wishing to be bound by theory, the inventors believe that addition of such retardants causes the formation of a temporary hydration layer on the surface of the mineral particles, temporarily inhibiting hydration of magnesia to the stable hydroxide form of magnesium hydroxide.

Any suitable retarding agent may be used, such as a weak acid (e.g. acetic acid, citric acid, tartaric acid, ascorbic acid, boric acid, sodium gluconate, phosphoric acid and several degradable derivatives of the phosphoric acid). The use of cheap and widely available food grade vinegar (a form of acetic acid) has, for example, been found to be particularly effective for improving the workability of the mineral aggregates used for the manufacture of granular or cellular seedling cubes and grow trays for hydroponics industry

The setting time, involving both the initial and final setting time is closely related to changes in the rheological properties of mineral constituents in the mineral aggregates, after adding water. The setting time of the moulded compositions of the present invention is generally fast, with the final setting for non-retarded methods generally obtained in the range of 5 minutes and 15 minutes but more typically in the range of 5 minutes to 10 minutes.

The amount of a retardant to be used will vary according to microstructural engineering and manufacturing requirements and will depend on the mineral mixture and the additives included in the mixture, such as water absorbing organic fibres. In practice and given the teachings of this invention, a person skilled in the art would be able to establish the most appropriate retardant type and amount to be used. Generally, the retardant added to the mineral mixture would be less than about 5% relative to total weight of mineral mixture (w/w), more preferably in the range of 0.01% and 1.5% by dry weight.

### Agglomeration—Standard Method

In some embodiments, the present invention provides mineral-based composites prepared from finely ground mineral mixtures including bassanite, magnesia and arcanite, for the manufacture of plantable agricultural containers, wherein an appropriate agglomeration apparatus is utilised to produce mineral aggregates (and hence products) having granular texture.

Agglomeration is a surface chemical reaction and is dependent upon the surface tension of water and capillary action between the particles, a phenomenon which may advantageously be used for the manufacture of granulated fertilisers, as described in the following embodiment. In the present invention, the surface chemical reaction phenomenon is achieved by rapid precipitation of syngenite that adheres to and acts as an effective binder of the granules formed in the mineral aggregate. The granules thus formed quickly obtain form stability while dehydrating near instantly because of constant tumbling of the granules that are in direct contact with air at room temperature.

Agglomeration apparatus suitable to produce granular mineral aggregates may, for example, be a conventional rotating bottle or other pellet making apparatus, such as a tumbler. Typically, a predetermined amount of fully dried and finely ground precursor mineral mixture is mechanically and integrally mixed in the agglomeration apparatus, whilst being sprayed with up to 10% w/w water (relative to weight of the mineral mixture) to moisturize the resulting granules. This process is conducted using water having room temperature which requires curing times in the range of 15 to 30 minutes, depending on a number of factors including, but not limited to the amount of the arcanite in the mineral mixture, the volume of material in the tumbler, mixing speed, and humidity of the material in the tumbler.

The agglomeration process can also be advantageously performed in combination with seeding, as described above, by incorporating a seeding agent such as finely ground bassanite or arcanite. A combined agglomeration and seeding method enhances the equilibrium between surface tension of water and capillary action between the particles, and can therefore effectively reduce the overall agglomeration time while promoting the production of products such as agricultural containers with granular texture. As noted above, such a texture can providing a desired water retention capacity for specific applications.

### Agglomeration—N-P-K Pellets Insertion Method

In some embodiments, a method for producing nutritive pellets (referred to as “N-P-K pellets”) comprised of a predetermined mixture of mono ammonium phosphate (MAP) and arcanite is provided, A thin rim of the mineral aggregate of the present invention may be formed around the MAP and arcanite mixture during the agglomeration process. The N-P-K pellets produced according to teachings of the present invention contain the three key nutrients of plants in the form of two highly soluble yet unreacted minerals (MAP and K₂SO₄) in discrete coated pellets. The addition of these pellets and their incorporation into the mineral aggregates can be precisely controlled to produce containers with nutritious value specifically targeted for a plant or plantation type or for controlling the rate of degradation of the container.

As used herein, the term “pellet” relates to a preformed and shaped material having relatively uniform dimensions in a given lot, and holding this form until its incorporation in the mineral mixture prepared for use in production of agricultural containers. Neither the shape or size of the pellets are limiting factors in the present invention; pellet shapes can be cylindrical, spherical or any other shape. The size of spherical or substantially spherical pellets can range from about 0.2 mm to 20 mm across.

The N-P-K pellets may be produced, for example, using a conventional pelletiser apparatus such as a rotating bottle or a tumbler (as described above). The curing time of the N-P-K pellets is within the range of 5 minutes to 10 minutes, depending on the mass ratio of the mineral mixture to total amount of MAP and potassium sulphate and to a lesser extent the volume of material in the tumbler, mixing speed, and humidity of material in the tumbler.

Based on experimentation using various ratios of mineral mixture to total amount of MAP and potassium sulphate, ratios between 2:1 and 1:1 typically provide favourable operating conditions and curing time.

### Methods to Accelerate Hardening Time

In some embodiments, the hardening time of the form stable moulded products of the present invention can be accelerated/shortened for the purpose of reducing manufacturing time and cost of the composites, without compromising its structural integrity and degradability. An accelerated hardening time might be achieved by means of (a) micronisation of the constituents of the precursor mineral mixture, (b) increasing the amount of arcanite at the expense of bassanite in the mineral mixture, (c) seeding via an aforementioned embodiment, or (d) combinations thereof.

In method (a), the constituents of the precursor mineral mixture are even more finely ground, such that they become micronised, which further increases particle packing density and reactive surface area of individual particles, while reducing the ratio of inter-particle water content in the mineral aggregate to that of syngenite binder that is diagenetically precipitated in the structural matrix of the moulded article. In this method, the particle size of finely ground individual constituents of the mineral mixtures may be further reduced by an appropriate micronising grinder to within the range of 0.01 mm and 0.05 mm across, and preferably in the range of 0.01 mm and 0.03 mm across.

In method (b), an accelerated hardening time is obtained by reducing the ratio of gypsum to syngenite present in the mineral aggregate by increasing the amount of arcanite at the expense of bassanite in the precursor mineral mixture. Such an adjustment in the ratio of the components of the mineral mixture advantageously causes faster binding and initial hardening effects, due to presence of a higher percentage of syngenite binder in the mineral aggregate, at the expense of lower gypsum percentage. The hardening process of this method does not require any additional rheology-modifying binding agent. In this method, the upper limit of arcanite in the mineral mixture can be 25% relative to total weight of dry aggregate (w/w) but preferably in the range between 5% and 8% dry weight.

In method (c), seeding can be used to accelerate the hardening without compromising the structural integrity and degradability of the containers.

The reduction in the overall hardening time of the moulded products using these methods (and without using any external heating source or chemical additives) can vary between 15% and 35%, depending on the type and amount of fillers and colouring agents added to the mineral mixtures. A person skilled in the art can apply these methods in various combinations to determine an optimum hardening time for any given product and mineral mixture.

As commonly known, the ability to rapidly harden an article is a major consideration in the microstructural design and economics of mass manufacturing of the containers of any type. Conventionally, the hardening process of a moulded container is accelerated at added cost by artificial means of evaporative dehydration, for example, exposing the container to heated air such as passing it through a conventional drying tunnel or using a hot air blow dryer. The efficiency of drying by such means is influenced by time, temperature, air speed, surface area, and thickness of the material to be dried. Generally, the higher the temperature and air speed the shorter the drying time; however, these require additional costs associated with the use of particular water-dispersant binder or heating of the moulds.

In contrary, the hardening time of the products/containers of the present invention can be shortened without the need for heating of either the moulds, nor the demoulded articles. The products/containers of the present invention are cured and can gain sufficient structural integrity and strength within a week of drying after demoulding in room temperature (15-35° C.), without the use of any particular chemical additives. Furthermore, they are produced in a form ready for proceeding through the remaining manufacturing processes, i.e., printing, coating, painting, engraving and packaging. The above-mentioned advantages of accelerated hardening of compositions of the present invention provide distinct handling, manufacturing time and cost advantages to the products/containers of present invention, particularly for containers requiring high water retention capacity for use in hydroponic application.

Shaping the Forming Mineral Aggregate into a Shape of the Product

Once the diagenetic reactions described above are underway, the intermediate mineral aggregate is shaped into a shape that approximates that of the product that is desired to be formed. As described herein, a specific application of the present invention relates to the production of plantable containers for plants and hence, the mineral aggregate may, for example, be shaped into the shape of a container for plants. It is acknowledged that slight changes in shape may occur as the product dries out, but these can easily be accounted for in the design process.

Any suitable shaping process may be used. Typically, however, the mineral aggregate would be shaped into the shape of the product by pouring into a mould. In some embodiments, conventional compression moulding apparatus can be used, where the mineral aggregates are placed into an open outer (female) mould before the inner (male) mould is compressed upon the outer mould to provide a closure under pressure and force the material to contact all areas of the moulds without heating the mould cavity. Throughout the process, the pressure is maintained until the mineral aggregate has set and the mineral-based composite formed, after which the inner mould is released and the moulded product is removed for hardening at room temperature or by accelerated drying using a low temperature heat source.

In another embodiment a conventional injection moulding apparatus can be used for manufacture of degradable products such as plantable agricultural containers. In such embodiments, the well-mixed mineral aggregate is injected via a barrel by force into a mould cavity, where it sets in the configuration of the cavity before its removal for hardening at room temperature (or by accelerated drying using a low temperature heat source). Because of high workability of the mineral aggregates of the present invention, the moulds for both compression and injection moulding can be easily designed by a design engineer and made by a mould-maker with relevant tool making skills. The choice of moulding method is dependent on the constituents of the mineral mixture and desired functionality, ergonomics and aesthetics of the final article.

The inventors note that these moulding methods can be used to manufacture a variety of plant containers, from small and simple grow cubes to the entire body of highly functional complex-shape plantable agricultural containers, with a high degree of dimensional accuracy with short cycle time. As would be appreciated, such would be competitive with the mass manufacturing utilised to produce conventional plastic plant containers.

### Allowing the Mineral Aggregate to Set, Whereby the Mineral-Based Composite and Product is Produced

Once shaped into the shape of the product, the mineral aggregate is allowed to set, whereupon the mineral composite/product is produced. The setting time of the mineral aggregates of the present invention is dependent on the content of water added to the mineral mixture, the reaction temperature and mixing conditions at the time of reaction.

In some embodiments (especially those where an excess of water was used, or where a more rapid drying time is required), the mineral aggregate may be set by heating to an elevated temperature (e.g. up to about 60° C.), although this would increase the energy requirements and hence cost of production so may be undesirable. In alternative embodiments, therefore, the mineral aggregate may set by allowing it to dry at room temperature for about a week.

Specific embodiments of the method of the present invention will now be described by way of illustrative example only.

### Plant Containers Having a High Water Absorption Capacity and Water Retention Capacity

In some embodiments, the present invention may provide mineral-based composites for use in manufacturing of degradable plantable agricultural containers, where the cavity of the containers have high water absorption and retention capacities such that they act as a slow release carrier of water, but without compromising the structural integrity or degradability of the container.

As used herein, water absorption capacity (WAC) refers to the weight percentage of water held by a container (or, more generally, a product). As used herein, water retention capacity (WRC) refers to volumetric capacity of a container to hold water absorbed by the body of the container for a period of time until the container reaches its original dry weight including free water. WRC is expressed in total number of days to reach its original dry weight at room temperature.

WAC and WRC are interrelated, and both represent key functional advantages of the containers/products of the present invention. The WAC and WRC values are dependent on a number of micro engineering design and manufacturing variables, with the key ones being the extent of aeration and/or agglomeration applied, the body thickness of the container, as well as the type and amount of coating and additives used in the manufacturing process. The containers of the present invention generally have water absorption values in the range of 25% and 55%, with corresponding water retention values varying between 3-20 days, more commonly within 8-14 days.

Manufacturing uncoated agricultural plant containers having high water absorption and retention capacities can be accomplished using a number of methods disclosed herein, which may be applied either individually or in various of the combinations listed below:
agglomeration of the mineral aggregates to produce containers with granular body texture;
agglomeration of mineral aggregates containing perlite to produce moulded containers with granular body texture;
agglomeration aided with seeding of mineral aggregates containing perlite to produce moulded containers with granular body texture;
agglomeration of the mineral aggregates having untreated sawdust with additional arcanite to produce moulded containers with granular body texture;
aeration of the mineral aggregates to produce moulded containers with cellular body texture;
aeration aided with seeding of the mineral aggregates to produce moulded containers with cellular body texture;
aeration aided with seeding of mineral aggregates containing perlite to produce moulded containers with cellular body texture

Both the WRC and WAC of the agricultural containers of the present invention can be optionally further adjusted such that they can provide and maintain a balanced moisture content to soil in the plant container by selectively coating the containers (or part thereof) using an appropriate coating agent such as shellac. Such coating not only provides higher WRC for an extended time compared with uncoated containers, but also the ability to use such containers as standalone for indoor/outdoor ornamental containers for an extended time (prior to disposal of the container in soil for degradation).

Containers having a high WRC manufactured according to teachings of this embodiment can be used for a wide range of industrial and consumer applications, and also have environmental benefits that are unmatched by agricultural containers of prior art. For example:
Existing paper plant containers require a high drainage rate through a bottom aperture to avoid buckling of the paper material. In contrast, containers of the present invention retain their form in use.
In warmer climates, crops planted in conventional containers (e.g. such as those made from plastics, polymers, organic fibres and paper) can quickly dry out if not watered often enough.
The waste water generated by nurseries due to excess watering of plants cultivated using conventional containers can lead to multiple issues such as high water usage, nutrient runoff to waterways and salt build up in fibre-based containers. In contrast, containers of the present invention can have an elevated WRC, which substantially reduces the watering need and frequency, and consequently nutrient runoff. Furthermore, because they retain their structural integrity, they are reusable.
In contrast to agricultural containers of existing art, the increased air circulation in high WRC containers of the present invention provide continued transpiration of the leaves, avoiding moisture buildup around the leaves and repels parasites while minimising rotting of leaves.

### Plantable Containers for Plants

As described above, in some embodiments, the present invention provides mineral aggregates for use in the manufacture of mineral-based composite products in the form of chloride-free plantable containers for plants. Upon placement in soils, the containers degrade over a relatively short period of time due to the interaction of physical, chemical and biological processes, as will be described below. Due to their composition, as they degrade they generate a residue that provides conditioning effects on the receiving soils. The extent of degradability and soil conditioning effects can be optimised by either adjusting the proportion of additives, such as the N-P-K pellets and organic fibres described herein, relative to the other components of the precursor mineral mixture. Furthermore, the techniques used to make the containers (e.g. agglomeration, aeration or a combination thereof, as descried herein) will beneficially affect the structural and functional properties of the containers.

The containers remain form stable and structurally resistant to breakdown and adequately perform their intended containment function, provided that they are not exposed to the interactive forces of physical, chemical and biological processes in a soil environment. Once buried or otherwise discarded into the soil, however, they become exposed to processes of progressive dissolution of water-soluble minerals and binders, triggered by alternate wetting-drying events in the soil vadose zone, while being also subjected to physical and biological disintegration through plant root growth, decay of organic fibre and soil movement. At some point, the containers lose their physical integrity and become decomposed through reduction of the structural matrix to a dirt. The bulk of generated dirt is comprised of the least soluble mineral components, namely gypsum and magnesium hydroxide (and, optionally, organic fibres) which are well known for their soil conditioning effects. Consequential to the above-mentioned degradation processes, the nutrients (K, Mg, N, P, Ca) released from the disintegrating containers provide added nutritious effects to surrounding soils. The containers not transferred to soil or reused can be physically broken down into pieces and either discarded in soil or disposed in a landfill.

Once the containers are transferred to soil, the observed sequence of events leading to degradation of the containers include:
repeated change in the body volume of the containers due to alternate expansion and contraction driven by alternate wetting-drying cycles in the vadose zones of the soil profile;
selective dissolution of a lower mass of water soluble sulphate minerals (syngenite and magnesium sulphate) intermixed with a significantly lower solubility gypsum mass;
where N-P-K pellets are included in the composites, development of secondary porosity and permeability zones within the structural matrix of the containers due to selective dissolution of N-P-K pellets which secondary porosity and permeability zones act as conduits for fluid flow and plant root penetration;
plant root growth through the walls and base of the containers, together with soil pressure and other environmental forces progressively causing breakage, accelerating physical-chemical processes, leading to pulverisation of structural matrix into a residual powder;
release of minerals and nutrients to surrounding soils under continued wetting-drying cycles prevailing in the soil profile;
progressive integration of the less soluble minerals (gypsum and magnesium hydroxide) in the soil profile providing conditioning effects to surround soils

The mineral-based composite of the present invention may take any suitable form. In the embodiments described in further detail below, the mineral composite is provided in the form of agricultural containers, of the kind that are conventionally provided as plastic containers. Non-limiting examples of such containers include seedling/nursery containers, containers for forestry, landscaping and mine site tailings vegetation, and hydroponic containers.

Containers in accordance with the present invention may be advantageous because:
they can be produced from widely available mineral deposits or infinite seawater feedstock, neither of which leads to severe ecosystem disturbance, deforestation, nor generates waste, both commonly inherited in the manufacture of conventional agricultural containers;
a significantly lower energy intensity of production;
use of the containers leads to substantial reduction in plant watering needs and nutrient runoff; the two challenges being grappled with for decades by nursery operations and home gardeners, and now a serious community concern due to recurring droughts;
the containers are formed from self-binding and fast setting mineral aggregates, and conventional moulding apparatus can be used for their manufacture; and
once returned to earth, the planted containers degrade and provide soil conditioning and nutritive effects to the surrounding soils, thus eliminating the need for landfilling.

The containers can be planted directly into the soil or, optionally, contain one or more plants initially grown in other containers before planting into the soil. The containers are suitable for providing continuity in cultivating plants such as seedlings, cuttings, rooted cuttings, plug plants, vegetables and/or pot plants, or plant material (e.g. seed material). The containers may be used for cultivating plants from seed and propagation to mature growth stage, thus obviating the need for transplanting and transfers in a variety of agricultural, landscaping, forestry, mine tailings vegetation and hydroponic applications. The containers can be configured to contain a single plant or a plurality of plants, with the plants spatially distributed to promote health of the plants free of competition for space, nutrients, moisture or light.

The containers are provided with a cavity for holding plant material. The cavity has sidewalls and, optionally, a bottom portion that may include one or more apertures for drainage. The containers can be manufactured in sizes commonly used in commercial nurseries, broad acre production (short-term production), as well as in larger sizes suitable for woody nursery production (long-term production) which may include ornamental plants. The containers can be manufactured having a hollow body portion with or without a means for closure, depending on the extent of drainage and degradability requirements. The forestry, mine site tailings revegetation and landscaping tubes can incorporate a semi closure in the form a mesh base or a degradable fabric, such as jute, which is inserted at the bottom of the tube.

Examples of various containers in accordance with embodiments of the present invention will be described below.

### Seedling/Nursery Containers

In some embodiments, the present invention provides self-binding and fast setting compositions that can use conventional moulding apparatus for manufacture of degradable plantable agricultural containers that can be planted directly into the soil or optionally contain one or more plants initially grown in other containers before planting into the soil. The said containers are suitable for providing continuity in cultivating one or more plants such as seedlings, cuttings, rooted cuttings, plug plants, vegetables and/or pot plants, or plant material (for example seed material). The containers may be used for cultivating plants from seed and propagation to mature growth stage, thus obviating the need for transplanting and transfers in a variety of agricultural, landscaping, forestry, mine tailings vegetation and hydroponic applications. The containers of the present invention can be configured to contain a single plant or a plurality of plants therein, with the plants spatially distributed to promote health of the plants free of competition for space, nutrients, moisture or light.

The containers are manufactured from compositions disclosed in the foregoing embodiments and provided with a cavity for holding plant material which cavity has sidewalls and a bottom portion; optionally containers can be made with a bottom. The bottom portion includes one or more apertures for drainage. These containers can be readily manufactured in sizes commonly used in commercial nursery, broadacre production (short-term production), and can also be manufactured in larger sizes suitable for woody nursery production (long-term production) which may include ornamental plants.

In one embodiment, conventional compression moulding apparatus can be used wherein the mineral aggregates of the present invention are placed into an open outer (female) mould before the inner (male) mould is being compressed upon the outer mould to provide a closure under pressure and force the material to contact all areas of the moulds without heating the mould cavity. Throughout the process, the pressure is maintained until the composition has set after which the inner mould is released and the moulded article is removed for hardening in room temperature or by accelerated drying using a low temperature heat source.

In another embodiment a conventional injection moulding apparatus can be used for manufacture of degradable plantable agricultural containers of the present invention wherein the well mixed composition of the present invention is injected via a barrel by force into a mould cavity, where it sets in the configuration of the cavity and then removed for hardening in room temperature or by accelerated drying using a low temperature heat source. Because of high workability of the composition of the present invention, the moulds for both compression and injection moulding can be easily designed by a design engineer and made by a mould-maker with relevant tool making skills. The choice of moulding method is dependent on the constituents of the mineral mixture and desired functionality, ergonomics and aesthetics of the final article. Further, whereas other moulding methods can be applied by a manufacturer due to high workability and mouldability of the compositions of the present invention, the aforementioned moulding method preferentially used for manufacturing a variety of containers, from small and simple grow cubes to the entire body of highly functional complex-shape plantable agricultural container with high degree of dimensional accuracy with short cycle time, typical of the mass manufacturing such as plastic agricultural containers.

Horticultural containers of the present invention that can be generally used by nurseries and household gardeners include grow cubes, seedling trays and nursery pots as well as seedling containers for landscaping and forestry planting.

Grow Cubes of existing art include starter plugs which are a small solid growing medium for seed germination made from compressed paper, paper mulch and organic fibers, including peat. In one embodiment of the present invention grow cubes can be manufactured having a hollow body portion and may or may not have a closure means, depending on the extent of drainage and degradability requirements. Container shapes include cubic, elongated cubic, conical, funnel and cylindrical shapes in various sizes and wall thicknesses. In contrary to the grow cubes made from peat, the cubes made in any above mentioned shape from the composites of the present invention retain their structural integrity regardless of extent of wetting/drying and thus are reusable for multiple seedling cycles, thus adding to operational cost efficiency, reduced purchase cost to customers and substantially lower life cycle costs. (use this for products below)

Seedling Trays of existing art are comprised of 2 or more cups, largely made from plastics, and are used to grow multiple seedlings at once in a single tray before transfer to either larger containers/pots or transplanted to soil. Seedling trays of the present invention can have cups in various shapes including but not limited to cubic, elongated cubic, conical, funnel and cylindrical shapes which are perforated and may or may not have a closure means, depending on the extent of drainage and degradability requirements. The cups of the said seedling trays can be in various sizes and wall thicknesses depending on application; for example, the seedling trays having non-funnel shaped cups can be adapted for landscaping and forestry seedling applications by means of sharpened walls of bottomless cups for easy insertion into the landscaping or forestry soil.

Nursery Pots of existing art are almost entirely made of plastics and polymers because of functionality and manufactured in various shapes and sizes having a bottom closure for housing larger plants grown beyond seedling stage but requiring growth before transfer to soil. Nursery pots of the present invention can be manufactured in various sizes and wall thickness fall into two categories; namely, bottomed pots with drainage hole and bottomless pots. In one embodiment, the horticultural pots can be made from the composites disclosed in the first embodiment of the present invention using the aforementioned moulding methods to characterise with adequate structural integrity, consistent hardness and desirable functionalities including but limited to with high water retention capacity, stackability/nestability and eventual degradability upon return to soil.

Yet in another embodiment, because of the mouldability, fast setting and hardening characteristics, the compositions of the present invention can be agglomerated or aerated before subjecting it to moulding in an appropriate moulding apparatus in order to produce nursery pots having increased water retention capacity, adjust the bulk density, obtain a desired textural appearance/aesthetics of the nursery pots or a combination thereof.

Additionally, nursery pots can be manufactured to include fillers and additives to provide a finished product that satisfies microstructural engineering design requirements and performance criteria, as well as improving the aesthetics of the nursery pots for wide ranging market applications.

In yet another embodiment of broader significance, the compositions of the present invention offer significant flexibility for manufacture of horticultural containers that accommodate plant cultivation needs from germination to seedling, plant growth to harvest stage wherein grow cubes, made from organic fibres as well as grow cubes of the present invention can be directly placed inside the said nursery pots to enable growth from seedling directly to mature stage without the need for transplanting. Accordingly, the containers of the present invention can be manufactured in a range of capacities to fit many different growing needs of plant growth by accommodating/enclosing one or more single organic fibre based grow cubes, seed starting trays or seed propagation containers, thus eliminating the need for transplanting. Regardless of the size, shape and function, all containers of present invention become degraded upon return to earth.

The horticultural containers that can be manufactured in any desired dimensions using conventional moulding methods and the compositions of the present invention. It is within the skill of a designer of horticultural containers of the art to determine the sizes and wall thicknesses of various of the containers to achieve the desired functionality and characteristics.

Grow Cubes for nurseries and gardeners can be in any size with H:D ratio ranging from as small as 1:1 to as large as 2:1 with the thickness of the cubes altered by adjusting the space between the male (inner) and female (outer) moulds to obtain the desired performance criteria without adjusting the makeup of the mineral aggregates in order to accommodate a particular container thickness.

Seedling pots for landscapers and forestry planting can be in any size with H:D ratio ranging from as small as 2:1 to as large as 4:1. Seedling Trays for nurseries and gardeners can be in any size with individual containers within the tray having a H:D ratio ranging from as small as 1:1 to as large as 2:1. Nursery Pots can be in any size with H:D ratio ranging from as small as 1:1 to as large as 4:1.

The thickness of the aforementioned horticultural containers of any size and shape can be altered by adjusting the space between the male (inner) and female (outer) moulds to obtain the desired performance criteria without adjusting the makeup of the mineral aggregates; however, most articles requiring thin walls such as grow cubes will generally have a thickness in the range from about 1 mm to about 4 mm. Nevertheless, in applications where higher strength or stiffness is more important, the wall thickness of the article may range up to about 5 mm. Within the scope of the present invention, seedling trays and pots can have greatly varying thicknesses depending on the particular application for which the article is intended. However, most such articles will generally have a thickness in the range from about 2 mm to about 5 mm. Nevertheless, in applications where higher strength or stiffness is more important, the wall thickness of the article may range up to about 12 mm.

Hydroponic Containers—CEA

In some embodiments, the present invention provides self-binding and fast setting compositions that can use conventional moulding apparatus, such as compression moulding or injection moulding, for the manufacture of degradable horticultural containers suitable for controlled environment agriculture (CEA), wherein continuity in crop production from seed and propagation to mature growth stage can be achieved by obviating the need for transplanting and transfers. CEA is the process of growing plants inside a greenhouse or grow room. The controlled environment allows the grower to maintain the proper light, carbon dioxide, temperature, humidity, water, pH levels, and nutrients to produce crops year-round.

Contrary to net pots used in prior art for either conventional or passive hydroponic systems, the hydroponic pots of the present invention that can be generally used in CEA include pots with one or more circular or square wall openings in order of a 3 mm up to 12 mm across to allow solutions enriched in nutrient to pass through and satisfy the requirements of systems using conventional nutrient film technique (NFT). In the passive hydroponic system, pots of present invention are devoid of wall openings and solutions enriched in nutrient pass through the bottom opening of the pot. The hydroponic pots of the present invention provide means for achieving cost efficiency via reduced water, nutrient, labour, space and energy usage.

The shapes of hydroponic pot can include cubic, elongated cubic, conical and cylindrical and can be manufactured in various sizes and wall thicknesses depending on specific applications, pot size can range in H:D ratio from 1:1 to as large as 2:1 with the wall thickness achieved by adjusting the space between the male (inner) and female (outer) moulds to obtain the desired performance criteria. A person skilled in the art of pot making can easily define the desired pot shapes, sizes, wall thicknesses and modularity for target hydroponic plants to allow the said pots in plurality to function best for optimised air circulation and light exposure around the growing plants to be produced.

Yet in another embodiment, because of the mouldability, fast setting and hardening characteristics of the composition of the present invention, the aforementioned methods of agglomeration and aeration, with or without fillers and additives, can be applied conveniently for mass manufacture of high water and nutrient retention capacity hydroponic pots as an alternative to net pots currently available in markets.

### Containers for Forestry, Landscaping and Minesite Tailings Vegetation

In some embodiments, the present invention provides mineral-based composites suitable for manufacture of degradable plantable containers for use in forestry, landscaping and minesite tailings vegetation programs, wherein the said containers can be directly inserted into the substrate, with or without a suitable insertion apparatus, to provide controlled irrigation and desired growth environment to plants within the confines of individual containers.

Forestry and landscaping industries are historically the largest users of plantable containers but, compared with nursery operations, require a higher degree of operational and watering efficiency as the use of conventional and modern irrigation practices, such as drip feed and foliar water and nutrient applications are not feasible due to the remoteness of forestry and large scale landscaping operations.

Minesite tailings rehabilitation projects are another large user of plantable containers that often because of elevated levels of toxicity, acidity and salinity of the mine tailings, also require a high degree of operational self-sufficiency and regular monitoring to ensure the success of a vegetation program in remote areas. Furthermore, because of inherited acidity of the mine tailings and the nature of disturbed underlying rocks, a comprehensive site preparation works including pH adjustment by limestone application is often necessary prior to implementing a large scale plantation.

The degradable containers for forestry, landscaping and minesite tailings vegetation applications can be manufactured from the compositions of the present invention according to site or product specific requirements and considering micro engineering design parameters, such as the best fit formulation of mineral aggregates, additives and other related factors affecting the rheology of the composites are optimised, as well as textural features (pore size, permeability, granularity and cellularity, wall thickness, etc.) for achieving the desired water retention capacity in controlled irrigation environment.

In one embodiment, mouldable aggregates of the present invention, can be used to produce controlled irrigation agricultural containers for use in forestry, landscaping and minesite tailings vegetation applications. The containers generally used for planting seedlings for forestry and landscaping applications include plant tube pots, native tree tubes, super native tree tubes and cone-based tubes. Such forestry and landscaping containers can be conveniently manufactured in square, cylindrical, funnel and conical shapes and combinations thereof and are typically elongated with a pointed ending at the bottom for the purposes of propagating, seedling and growth of root cuttings. The tubes can be manufactured having a hollow body portion with or without a means for closure, depending on the extent of drainage and degradability requirements. The tubes can incorporate a semi closure in the form a mesh base or a degradable fabric, such as jute, which is inserted at the bottom of the tube. Optionally the tubes can incorporate internal ribs for root training. Such conical tubes can be manufactured in various sizes and wall thicknesses can be customised but typically follow the D:H ratios in the range of 1:1 to 1:5 and wall thicknesses is the range of 3 mm-10 mm.

Containers in the form of conical tubes can be specifically designed for ease of handling and fast plantation (two highly desirable requirements in forestry and minesite tailings rehabilitation projects) using a commercially available or custom-built seedling jab planter. Round conical tubes with a side drainage hole are particularly suitable for direct insertion of planted seedlings or cuttings into soil directly in large numbers. Additionally, the tubes can also be designed and manufactured from compositions of the present invention as trays of multiple tubes wherein each plantable tube is perforated along the top edge for ease of detachment for insertion into the substrate. The trays offer additional advantages of stackability

In addition to advantage of ease of stackability/nestability the tubes and trays of the present invention, offer a unique advantage of degradability after insertion into the substrate via the interaction of chemical, physical and biological process disclosed in the following embodiments.

Plantable containers of the present invention can be designed and manufactured according to site and product specific needs of forestry, landscaping and minesite tailings vegetation programs, in order to provide multiple functionalities that in plurality lead to improved operational efficiency, currently unavailable with existing containers. These functionalities may include one or more of the following:
high water retention capacity containers in the ranges specified in previous embodiments which acts as a water reservoir for the contained plants thus leading to significant water saving and watering cycle efficiency, particularly for plantations located in water scarce areas subjected to salinity ingress;
containers with controlled water delivery protect the contained plants from problems associated with water-logging and aridity in remotely located operations or terrains with limited human access;
point positioning of seedling containers ensures healthy plant growth and optimised vegetation coverage;
containers obviate the need for broadcast application of fertilisers and mulch at early stages of plantation;
containers, having high water retention capacity are particularly suited for plants requiring coarse sandy and gravelly soils;
containers, having stable moisture and air regime in the contained soil and fertiliser provide highly favourable growth conditions particularly for rooting of plants from cuttings;
containers, having regulated water retention capacity offer efficiencies better than drip irrigation, which clog after long usage, and require much less water than foliar irrigation, particularly in with high evaporation rates;
containers protect root zone of seedlings in mine site tailings vegetation from plant diseases and pests, as well as from toxicity, acidity and salinity ingress from surrounding substrate;
containers can be used effectively for steep slope minesite tailings plantation programs; and
containers act as soil conditioner upon degradation.

In summary, the containers of the present invention can substantially reduce costs associated with material handling, site preparation and planting operations in forestry, landscaping and minesite tailings vegetation programs due to the aforementioned functionalities. The high water retention capacity of the said containers obviate the operating issues such as the need for frequent watering during transport and delivery of the plants which negatively impacts the overall health of plantations

### Method of Cultivating a Plant in the Containers

A method for cultivating a plant in an agricultural container of the present invention may, for example, comprise the steps of:
placing a plant seed, seedling or a root cutting and growth medium in the container;
watering the container until the walls are wet which allows the container to hold water hence allowing less frequent subsequent watering intervals;
permitting germination of the plant seed, growth of the seedling or the plant in the container, and
permitting growth of the living plant in the container as a standalone pot; or optionally permanently transferring the cultivated container within soil, earth or mine tailings with the openings of the container below soil, earth or mine tailings surface to permit root growth from within the containment volume into the soil, wherein, after transplanting the container can degrade within the soil and provide conditioning effects to the surrounding soil.

The agricultural containers of the present invention are suitable for cultivating of various seedlings and plants regardless of the species of the seed, or the type, size and growth stage of the plant. The use of containers for cultivation of seeds and/or plants are independent of the characteristics of the medium used such as fertilizers, nutrient additives, mineral supplements, beneficial commensal microorganisms, and the like. If desired, the agricultural containers of the present invention can incorporate adequate amounts of pesticides, selective herbicides, fungicides or other chemicals to remove, reduce, or prevent growth of parasites, weeds, pathogens, or any other detrimental organisms. Furthermore, seedlings grown in grow cubes and plugs can be conveniently transferred to the containers of the present invention for further growth to avoid transplanting shock. Due to high water retention characteristics of the containers of the present invention plants cultivated in these containers can be packaged and colour coded prior to subjecting containers to prolonged storage/shipping without the need for refrigeration before delivery to final site or consumption.

### Degradable and Nutritive Containers

The mineral-based composites of the present invention may be used for manufacturing chloride-free plantable containers, which containers upon placement in soils become degraded over a relatively short period of time through interaction of physical, chemical and biological processes, generating a residue having conditioning effects on the receiving soils. The extent of degradability and soil conditioning effects can be optimised by either adjusting the proportion of additives, such as N-P-K pellets and organic fibre relative to main mineral mixture in the compositions or applying methods of agglomeration, aeration or a combination thereof, as disclosed in aforementioned embodiments.

The containers of present invention remain form stable and structurally resistant to breakdown and adequately perform their intended containment function, as long as they unexposed to interactive forces of physical, chemical and biological processes in soil environment. Once discarded into the soil they however become exposed to processes of progressive dissolution of water-soluble minerals and binders, triggered by alternate wetting-drying events in the soil vadose zone, while being also subjected to physical and biological disintegration through plant root growth, decay of organic fibre and soil movement. At some point, the containers lose their physical integrity and become decomposed through reduction of the structural matrix to a dirt. The bulk of generated dirt is comprised of the least soluble mineral components, namely gypsum and magnesium hydroxide and organic fibres which are well known for their soil conditioning effects such as sulphur amendment and pH adjustment of the receiving soils. Consequential to the above-mentioned degradation processes, the nutrients (K, Mg, N, P, Ca) released from the disintegrating containers provide added nutritious effects to surround soils. The containers not transferred to soil or reused can be physically broken down into pieces and either discarded in soil or disposed in a landfill.

The mineral aggregates may be used for the mass manufacture of plantable degradable agricultural containers using conventional moulding processes and compared with agricultural containers of prior art offer higher manufacturing workability, and lower life cycle cost of mass production while providing improved handling and packaging features, because of:
availability of a range of feedstock options from either plentiful and widely occurring natural mineral resources or from replenishable seawater in an economically and environmentally sound manner;
No need for heat energy for setting form and hardening, nor for additives such as binders, plasticisers and demoulding agents for hydraulically self-binding, fast setting and hardening of the mineral aggregates to enable mass production of the containers using conventional moulding apparatus at substantially reduced production and life cycle cost;
Superior mouldability and workability of the mineral aggregates allows for broad flexibility in microengineering design based on the selection of additives and modes of operating the moulding systems for mass production of agricultural containers in various sizes, shapes, thicknesses, textures and water retention capacities for diverse horticultural, forestry, landscaping and mine site tailings vegetation applications, without compromising the structural integrity and functionality of the said containers;
ease of handling, optimum stackability and availability of many options for packaging configurations for storage and long-haul transportation.

### EXAMPLES

### Example 1

For determining the mineralogical composition of composites in accordance with embodiments of the present invention and the setting time of the corresponding mineral aggregates, three tablets (for mineralogical identification) and respective stubs (for setting time measurement) were prepared from the same precursor mineral mixture, using a finely ground (ca. 0.01-0.05 mm particle size) mineral mixture comprised of 88% w/w bassanite, 10% w/w magnesia, 2% w/w arcanite (all by weight of dry mixture). The dry mineral mixture was first thoroughly mixed for about 2 minutes to which deionised water was added at the ratio of 53% w/w (by weight of total solid weight) and thoroughly mixed for an additional 2 minutes to produce a consistently uniform mineral aggregate. The resultant mineral aggregate was then transferred into cups of the same size and tapped onto a flat surface to flatten and shape into tablets, to produce three tablets, 1 cm in thickness and 5 cm in diameter, which were left to set in room temperature while measuring the pH of the mineral aggregates. The setting time of the tablets were determined using a Vicat needle apparatus (Labgo Vicat) with a needle 1.13 mm in diameter following guidelines recommended by the equipment supplier. As indicated in Table 1, the setting time of the composites ranging between 6-8 minutes with pH of the mineral aggregate varying between 12-13.

The mineralogical composition of each tablet, after hardening at room temperature for 21 days, was determined qualitatively by a combination of microscopic examination, using a standard laboratory petrographic microscope, and X-Ray Diffraction of powders produced from half of each tablet. A Bruker D8 DISCOVER XRD unit, operated at a voltage of 40 kV and a current of 40 mA, and a Diffractometer EVA V4.2 software were used for mineralogical determination. As shown in Table 1, gypsum and syngenite represent the major and moderate mineral components of the composites respectively, with brucite and epsomite/starkeyite forming the minor components. Starkeyite represents the trace component in one of tablets tested. The type of magnesium sulphate mineral recorded by XRD analysis depends on the hydration status of the composite, which is indirectly a reflection of the room temperature and humidity during the drying phase of the composite.

TABLE 1

| Mineral aggrgeate replicate number | 1 | 2 | 3 |
|---|---|---|---|
| pH of mineral aggregate prior to setting | 12 | 13 | 12.5 |
| Setting time (min) | 6 | 7 | 8 |
| Mineral abundance in the hardened composite | | | |
| Major (>30%) | Gypsum | Gypsum | Gypsum |
| Moderate (10-30%) | Syngenite | Syngenite | Syngenite |
| Minor (2-<10%) | Starkeyite, Brucite | Epsomite, Brucite | Epsomite, Brucite |
| Trace (<2%) | — | Starkeyite | — |

### Example 2

Using conventional compression moulding methods, a large number of agricultural containers of diverse sizes and shapes (bottomed and bottomless, cubic/cylindrical cubes, small/large conical/cylindrical/hexagonal pots/tubes) were produced using mineral aggregates, by hydrating finely ground mineral mixtures comprised of bassanite, magnesia, arcanite and various additives (excluding a reference sample with no additive) according to the procedure described in Example 1. For preparing the mineral aggregates, the ratios of magnesia was kept at 10% w/w, arcanite at 2% w/w (both by weight of dry mixture), water at 53% w/w (by weight of total solid weight), while the amount of bassanite varied between 81-88% w/w, depending on the amount of additives included (see Table 2). The containers were left at room temperature for 21 days to harden before determining their Water Absorption Capacity (WAC) and Water Retention Capacity (WRC), according to the procedure described below. Visual observations confirmed that all containers remained reasonably hard and maintained their original shape after completing absorption/retention trials.

WAC is defined as the percentage of water absorbed by the walls and the base of a container and measured as weight percentage of water absorbed by the container to that of the total dry weight of the container. This involved immersing a container in water for about 30 minutes then removing the excess water from the container before immediately determining the wet weight of the container and calculating the weight percentage difference between the wet and dry weights of the container.

WRC is a measure of duration (expressed in days) that an agricultural container holds water before reaching its dry weight. It was determined by monitoring the change in the amount of water absorbed over time by the walls and base of a container held in room temperature (in 20±8° C.), until the weight of the container has almost reached its original dry weight, due to evaporative water loss. WRC values were considered reasonable for a container having 5% w/w water (representing free water) in excess of the weight of the container dried in oven at 60° C. for 2 days.

As shown in Table 2, the WAC values of the listed containers vary in range from 22 wt % and 45 wt % and the WRC values range from 3 days up to 12 days. Trial observations indicate that neither the geometric shape nor the volume of the containers, or wall thickness of the containers had any discernible influence on WAC values. However, the inclusion of perlite, zeolite, untreated sawdust or combinations thereof in the mineral aggregate increased the WAC of the containers. Additionally, the containers with sawdust required longer time to absorb and desorb water compared to the containers without sawdust, reflecting the slow water absorption and desorption capacity inherent in untreated sawdust. Observations also indicate that a container's wall thickness plays a significant role in the WRC; this was seen in containers having wall thicknesses of 5 mm and above (nursery pots, and forestry and minesite tailing revegetation tubes) with WRC values averaging 20% higher in retention days compared to that of containers with wall thicknesses less than 5 mm (such as grow cubes and hydroponic pots).

TABLE 2

| Additives | | Additive | Water Absorption | Water |
|---|---|---|---|---|
| Included | | (wt % of | Capacity (WAC) | Retention |
| in the | | total | (wt % of dry | Capacity |
| Mineral | No of | mineral | weight of | (WRC) |
| Aggregates | Containers | mixture) | container) | (days) |
| None | 34 | — | 23-35 | 3-12 |
| Quartzose Sand | 25 | 3-7 | 25-30 | 7-12 |
| Perlite | [symbol] 10 | 3-7 | 31-41 | 7-12 |
| Zeolite | [symbol] 7 | 3-7 | 32-43 | 3-5 |
| Vermiculite | 6 | 3-7 | 31-39 | 7-12 |
| Wood Fibre (Sawdust) | 20 | 3-7 | 31-45 | 7-12 |
| Colour | 31 | 0.05 | 25-34 | 3-12 |
| NPK Pellets | 15 | 5 | 22-36 | 7-12 |

### Example 3

To assess the effects of seeding on the setting time of mineral based composites, 3 stubs of the same mineral aggregate (with no seeding agent) were prepared using the preparation method given in Example 1. Apart from these reference stubs, 10 additional stubs were prepared by seeding the same mineral aggregate (after the precursor mineral mixture was mixed with water) with finely ground mineral bassanite and 7 other stubs with finely ground mineral arcanite. In the case of mineral aggregates for seeding trials, the ratios of magnesia was kept at 10% w/w, arcanite at 2% w/w (both by weight of dry mixture), while the amount of bassanite varied between 80-87.5% w/w and amount of water varied between 41% and 60% w/w (by weight of total solid weight), depending on the type and amount of seed used. The setting time of the tablets were determined using a Vicat needle apparatus (Labgo Vicat) with a needle 1.13 mm in diameter following the guidelines recommended by the equipment supplier. The seed dosing rates (expressed as % of total weight of dry mineral mixture) and setting time are given in Table 3. As shown, the setting times of both bassanite and arcanite seeded composites were reduced substantially compared to that of unseeded composites.

TABLE 3

| Seed | No of | Seed Dosing Rate (as wt % | Setting Time |
|---|---|---|---|
| Type | Test Stubs | of dry mineral mixture) | (min) |
| None | 3 | — | 6-8 |
| Bassanite | 10 | 2-8 | 3-5 |
| Arcanite | 7 | 0.5-3 | 4-5 |

### Example 4

The dosing effects of weak acids in the form of acetic, citric, ascorbic and tartaric acids, with concentrated phosphoric acid (85%) (for comparison), on the setting time of mineral aggregates in accordance with embodiments of the present invention were assessed using 5 pairs of stubs dosed with the weak acid retardant, each pair comprised of one aggregate coloured with iron oxide pigment and another without colour pigment. These stubs and an undosed reference stub were prepared using the method of preparation described in Example 1. Table 4 tabulates the acids and their related dosing rates. In the case of mineral aggregates dosed with acids, the ratio of magnesia was kept at 10% w/w, arcanite at 2% w/w (both by weight of dry mixture), the amount of water at 53% w/w (by weight of total solid weight), while the amount of bassanite varied between 87-88% w/w (by weight of dry mixture), depending on the type and amount of acid used.

The setting times of acid dosed stubs were measured using a Vicat needle apparatus (Labgo Vicat) with a needle 1.13 mm in diameter following guidelines recommended by the equipment supplier and the results are given in Table 4. As indicated, setting time of the mineral aggregates dosed with acids increased several fold compared to that of the undosed stub. The longest retardation time related to mineral aggregates dosed with tartaric and ascorbic acids, which was in excess of 90 minutes, regardless of inclusion of oxide colour pigment, or lack thereof.

TABLE 4

| | No of | Acid Dosing Rate (as wt % | Setting |
|---|---|---|---|
| Retardant Type | Samples* | of dry mineral mixture) | Time (min) |
| None | 1 | — | 6 |
| Acetic Acid | 2 | 1 | 16-26 |
| Citric Acid | 2 | 0.1 | 45-50 |
| Ascorbic Acid | 2 | 0.15 | 91-96 |
| Tartaric acid | 2 | 0.1 | 92-95 |
| Phosphoric Acid (85% Conc.) | 2 | 1.1 | 65-70 |

*Sample pair refers to coloured and uncoloured mineral aggregates

### Example 5

Compressive strength and bulk density of mineral based composites in accordance with embodiments of the present invention were determined using two groups of mineral aggregates, with one group (non aerated) using 47-53% w/w water (by weight of total solid weight) and another group (aerated) using 10% w/w water (by weight of total solid weight). Each group has a reference sample, a coloured sample and an uncoloured sample (with the latter sample including quartzose sand as additive). The reference samples were prepared using the method of preparation given in Example 1. The coloured samples were prepared from 88% w/w bassanite, 10% w/w magnesia, 2% w/w arcanite and 0.05% w/w iron oxide pigment, while the uncoloured samples with additive were prepared from 82% w/w bassanite, 10% w/w magnesia, 2% w/w arcanite and 6% w/w sand (expressed as % of total weight of dry mineral mixture). Table 5 provides a tabulation of the samples and test results.

Compression tests were carried out following the ASTM C472 guidelines. Cubic test specimens (44 mm×44 mm×40 mm) were prepared from the above described mineral aggregates and subjected to drying in room temperature over 43 days, starting from the date of setting. Compressive strength of the specimens were determined using Shimadzu AG-IC 250 kN test machine. As indicated in Table 5, the compressive strength of nonaerated composites ranged between 5.57 MPa and 8.21 MPa, with the aerated composites having compressive strengths ranging between 0.88 MPa and 1.97 MPa, significantly lower than their non-aerated counterparts.

The bulk densities of the corresponding test specimens are also given in Table 5, indicating corresponding bulk densities ranging between 1.06-1.21 g/cm³ for nonaerated composites with the aerated composites being relatively lighter (0.98-1.17 g/cm³) than their nonaerated counterparts. The measurements point to direct correlation between compressive strength and the bulk density of the composites with the latter dictated by both the type and amount of the additives and the secondary porosity generated by the aeration process.

TABLE 5

| Additives | | Additive wt % | | Com- |
|---|---|---|---|---|
| Included | | (as wt % of | Bulk | pressive |
| in the | | dry mineral | Density | Strength, |
| Composite | No of Samples | mixture) | (g/cm3) | (Mpa) |
| None | 3 Nonaerated samples | — | 1.07-1.20 | 7.17-8.21 |
| Sand | 2 Nonaerated samples | [symbol] 6 | 1.08-1.21 | 6.80-8.17 |
| Colour | 2 Nonaerated samples | 0.05 | 1.06-1.10 | 5.57-7.88 |
| None | 2 Aerated samples | — | 0.98-1.10 | 0.88-1.80 |
| Sand | 1 Aerated sample | [symbol] 6 | 1.17 | 1.97 |
| Colour | 2 Aerated samples | 0.05 | 1.10-1.12 | 0.96-1.16 |

### Example 6

Degradation of products such as agricultural containers when buried in soil occurs by a complex combination of physical, chemical and biological processes acting simultaneously. Considering that planted containers are subjected to intermittent wetting and drying events once buried in soil, the inventors have assessed the degradation of containers in accordance with the present invention in both aqueous and soil environments, using the two inter-related parallel trials described below.

### Trial 1

Trial 1 involved the assessment of hardness, as a measure of degradability potential, using a needle penetration test on a variety of containers and reference tablets that were immersed in water over a long time. This trial was conducted to provide an understanding of the influence of soil water/moisture regime on the physical integrity of the containers, knowing that containers once buried, become exposed to vagaries of aqueous chemical reactions (solid-liquid reactions) active in soil vadose zone. The procedure used involved penetrating a stainless steel needle through the walls and base of containers which had been immersed in water for extended periods. This method was selected amongst others as it is a non-destructive index test for continued assessment of the hardness of containers beyond the measurements reported in this example.

Overall, 86 agricultural containers having various sizes, shapes and dimensions were prepared according to the method described in Example 1. Additionally, 28 tablets of the same compositions as the containers and prepared according to the method described in Example 1, were used for comparative assessment. The containers and tablets were both made of mineral aggregates produced by hydrating finely ground mineral mixtures comprised of bassanite, magnesia and arcanite. As indicated in Table 6 (and excluding the reference samples), other containers and tablets included various additives of the kind described above.

The containers and tablets were placed in laboratory beakers and petri dishes, respectively, and fully immersed in pre-determined amounts of freshwater. If required, additional water was added to ensure that the containers and tablets were fully immersed. The water in the beakers and petri dishes was gently agitated by hand before measuring their pH values. The first complete observation round was undertaken 6 months after the date of immersion of the last sample and it included visual observation of the physical features of the containers and tablets, including structural integrity, scratch-ability and container/tablet decolouration effects as well as needle penetration test. Table 6 provides summary results of the second observation round, which was carried out over 10 months after the immersion of the first container, including the visual assessment of physical status and hardness of the immersed samples and pH of water in the beakers and petri dishes on the day of hardness measurement.

For obtaining the indicative hardness of the containers and tablets, a needle penetration test method was applied, where the extent of penetration of a 2 mm diameter needle with blunt end through the walls and bases of the immersed containers was used. For a comparative base, two cork tablets, each 10 mm in thickness but different compaction, were used for establishing a penetration scale. In the case of the higher compact cork tablet with zero mm needle penetration, a hardness scale of “5” was assigned, which is closely equivalent to mineral talc hardness in Mohs Scale of mineral hardness (a commonly used scale in earth sciences for characterising the scratch resistance of various minerals). For the less compact cork tablet with 5 mm needle penetration a hardness scale of “0” was assigned. As tabulated in Table 6, needle penetrations of less than 5 mm were obtained for all containers and tablets used for this trial, and they were assigned a hardness scale varying between these two extremes.

The visual observations indicate that, firstly, as shown in Table 6, the majority (approximately 74%) of the containers remained intact after a minimum of 10 months continuous immersion in water, as evidenced by the integrity of their original wall structure and base. However, needle tests of the containers and reference tablets indicated that most of the intact containers were soft to mildly hard, as shown by their hardness scale and ease of needle penetration through the walls and base of the containers with minimal pressure. No collapsed container was observed during the first 6 months of water immersion. Close-up viewing indicated that the shattering, followed by collapse of the walls of some of the containers was due to the development of rounded dissolution holes, outlining the location of precursor N-P-K pellets. A similar feature is seen in partially collapsed buried containers, wherein the open holes closely mimic the location of precursor N-P-K pellets, now partially or fully dissolved.

Secondly, the visual observations point to retention of the colour and colour intensity of the containers, regardless of the type and dosing rate of the colourants, the presence of other additives, or pH of water in contact with the containers which remained mildly alkaline during 10 months (or longer) monitoring period.

Thirdly, due to the high water absorption capacity, the containers with sawdust show more susceptibility to volume expansion, leading to weakening of the structural matrix, reduction in hardness and eventual collapse of the containers. This process of accentuated container softening and disintegration is particularly more pronounced in containers having sawdust and N-P-K pellets in combination, and also visibly seen in such containers that are buried in soil and subjected to alternate wetting and drying events, wherein the collapsed fragments are rimmed with a brownish organic resin released from the sawdust.

### Trial 2

Trial 2 involved the visual assessment of the status of degradation of planted containers placed in soil, followed by microscopic examinations and determination of composition of the residue left behind from degraded containers in soil, using the X-Ray Diffraction method described in Example 1.

For a broad-based assessment, a large number of containers, representing replicates of the container types used in Trial 1 were planted with seedlings of plant species for nursery, forestry and minesite tailings revegetation, as well as seeds of leafy greens. All were placed in soil for long-term degradation observations.

For evaluating the degradation processes and indicative duration of the planted containers once buried, five replicate sets of uncoloured nursery containers in accordance with the present invention, having the same size, shape and dimension, were selected for qualitative assessment. One set was devoid of any additive (as the reference containers) and the other replicate sets each respectively contained quartzose sand, sawdust, NPK pellets and NPK pellets with sawdust. All replicate containers were planted with a single perennial species (Eucalyptus saligna, “Sydney Blue Gum”) and placed in rows in a custom-built raised garden bed with a Perspex front shield for the ease of viewing. Visual observation of the containers after 6 months of healthy plant growth, indicated partial or total dislodgement of the lower half of all containers from their main body, clearly due to plant root growth through the walls as well as through the holes generated by dissolution of precursor N-P-K pellets. Close-up viewing of a duplicate of each set removed from the raised garden bed indicated that the dislodged portions of the containers were largely decomposed into whitish loose and friable particles of 5-10 mm across.

After 12 months of plant growth to mature stage, the second duplicate of each plant and its surrounding soil were carefully removed from the raised garden bed, placed on a bench, and subjected to a combination of visual observations and microscopic examination. The visual observations indicated that the roots of all plants reaching the mature stage had invariably outgrown beyond the peripheries of the pre-existing containers.

The microscopic observations, supported by XRD mineralogical determinations, indicated minor presence of a whitish nodular residue, in the range of 0.2-5 mm across, was comprised primarily of mineral gypsum (over 98%), with trace amounts of brucite and magnesium sulphate, in the form of epsomite mineral, also recorded in some XRD scans. Similar gypseous residue were recorded in some of the containers planted with seedlings of nursery, forestry and minesite tailings revegetation specie; the majority of the plants were however devoid of any residue, indicating full degradation.

Based on the outcomes of the above trials, it is the view of the inventors that the agricultural containers of the present invention, once placed in soil, will degrade typically within a 6-12 month period, with some containers leaving behind a gypseous residue beneficial to surrounding soils as a soil conditioner. As would be appreciated by horticulturists, the degradation rate and its duration will however depend on a number of parameters including container composition, plant watering and soil water regime, physical disturbance and biological activities, which are known to operate simultaneously in a typical soil profile.

TABLE 6

| | | | | Number of Days | | | |
|---|---|---|---|---|---|---|---|
| | | | | Containers/Tablets | | Physical Status of | |
| Additives | | | | Immersed in Water | Water pH Range | Containers/Tablets | Hardness |
| Included in | Weight | | Number of | before the date of | on the date of | on the Date of | Range of |
| the Mineral | % of | Number of | Reference | Needle Penetration | Needle Penetration | Needle Penetration | Containers/ |
| Aggregates | Additives | Containers | Tablets | Test | Test | Test | Tablets |
| None | — | 10 | 11 | 370 | 7.19-8.17 | All containers intact | 3-5 |
| Quartzose Sand | 3-7 | 3 | 0 | 365 | 7.02-8.73 | All containers intact | 4-5 |
| Perlite | 3-7 | 1 | 0 | 335 | 7.03-7.94 | All containers intact | 2-4 |
| Vermiculite | 3-7 | 3 | 3 | 320 | 7.14-8.21 | All samples intact | 2-4 |
| Wood Fibre | 3-7 | 12 | 8 | 324 | 7.07-8.52 | 1 fully and 2 partially | 1-3 |
| (Sawdust) | | | | | | collapsed containers | |
| Colour | 0.05 | 3 | 12 | 365 | 7.32-8.64 | 1 partially | 2-4 |
| | | | | | | collapsed container | |
| NPK Pellets | 5 | 15 | 5 | 365 | 7.73-9.09 | 1 fully and 3 partially | 1-2 |
| | | | | | | collapsed containers | |
| Wood Fibre | 3-7 | 8 | 0 | 314 | 7.05-7.98 | 1 fully and 1 partially | 1-3 |
| (Sawdust) + | | | | | | collapsed containers | |
| Perlite | | | | | | | |
| Wood Fibre | 3-7 | 19 | 4 | 324 | 8.15-9.38 | 5 fully and 2 partially | 1-2 |
| (Sawdust) + | | | | | | collapsed containers | |
| NPK Pellets | | | | | | | |
| Wood Fibre | 3-7 | 4 | 1 | 320 | 7.74-7.84 | 1 fully and 1 partially | 1-3 |
| (Sawdust) + | | | | | | collapsed containers | |
| Vermiculite | | | | | | | |
| Wood Fibre | 3-7 | 1 | 0 | 320 | 8.39 | 1 fully and 2 partially | 1-2 |
| (Sawdust) + | | | | | | collapsed containers | |
| Vermiculite + | | | | | | | |
| NPK Pellets | | | | | | | |
| Vermiculite + | 3-7 | 3 | 1 | 320 | 8.08-8.55 | 1 fully and 1 partially | 1-3 |
| NPK Pellets | | | | | | collapsed containers | |
| Quartzose Sand + | 3-7 | 1 | 0 | 335 | 8.21 | All containers intact | 3-4 |
| Perlite | | | | | | | |
| Quartzose Sand + | 3-7 | 3 | 0 | 365 | 8.04-8.81 | 1 partially | 3-4 |
| NPK Pellets | | | | | | collapsed container | |

As described herein, the present invention provides degradable mineral composites and products, particularly containers for plants, which can be formed from or of the mineral composite. Embodiments of the present invention provide a number of advantages over existing plant containers, some of which are summarised below:

### Resources

availability of widely occurring mineral deposits and infinite seawater resources to enable sustainable manufacturing of the containers in multiple locations at any scale according to local and regional market demands;

### Manufacturing and Mass Producibility

high mouldability and workability make the composites amenable to optimised engineering design for economic mass manufacture of a wide range of plantable agricultural containers, having diverse textural features and functionalities for a wide range of cropping applications;
composites are self-binding, fast setting/hardening, free of rheology modifying agents and consume low energy in manufacturing operations;

### Functionality

The composites, containers, systems, assemblies, and methods of the present invention provide additional stability for a plant's growing environment and enable prolonged storage;
A key feature of the containers of the present invention relates to reduced watering requirement and nutrient runoff from the planted containers due to controllable water retention capacity of the composites;
The containers can advantageously be disposed in the soil along with the plant roots so that no step of removing the plant roots from the container is needed.
Because the containers of the present invention provide structural protection for a determinable period to the roots and soil provided in the container relative to the rest of the soil, plants provided in the container have the benefit of balance between moisture content and aeration for retaining the original germination mix for a longer period of time as compared to plants that are removed from conventional containers and planted directly into the soil. By controlling manufacturing parameters of the containers of the present invention, the period of structural protection can be controlled.

### Degradability/Reuse/Recycle

The highly form stable containers with hardened structural matrix require no repurposing for reuse/recycling;
The containers are chloride free;
When placed in soil, the containers become progressively degraded to a gypseous residue that provides conditioning effects to surrounding soils;
It will be appreciated that a skilled manufacturer of containers is capable of selecting certain composites and microengineering design parameters according to the teachings of the present invention in order to optimise the length of time required for biodegradation of the containers.

It will be understood to persons skilled in the art of the invention that many modifications may be made without departing from the spirit and scope of the invention. All such modifications are intended to fall within the scope of the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A mineral-based composite comprising gypsum, syngenite, brucite and a hydrated magnesium sulphate mineral, wherein the mineral-based composite is adapted to degrade when buried.

2. The mineral-based composite of claim 1, wherein the mineral-based composite has a shape that defines a product.

3. The mineral-based composite of claim 2, wherein the product is a plantable container for plants.

4. The mineral-based composite of claim 1, wherein the hydrated magnesium sulphate mineral is starkeyite and/or epsomite.

5. The mineral-based composite of claim 1, wherein the mineral-based composite further comprises discrete fertiliser pellets distributed therethrough, wherein the fertilizer pellets comprise monoammonium phosphate and arcanite.

6. (canceled)

7. The mineral-based composite of claim 1, wherein the mineral-based composite is porous.

8. The mineral-based composite of claim 1, further comprising any one or more of the following: one or more inorganic fillers, one or more organic fibres, a colourant and a coating agent.

9. (canceled)

10. (canceled)

11. (canceled)

12. (canceled)

13. A plantable container for plants that comprises a mineral-based composite comprising gypsum, syngenite, brucite and a hydrated magnesium sulphate mineral, wherein the container is adapted to degrade when buried.

14. (canceled)

15. A method for producing a product that is formed from a mineral-based composite and which degrades when buried, the method comprising:
hydrating and stirring a precursor mineral mixture that comprises finely ground bassanite, magnesia and arcanite, whereby a self-binding and shapeable mineral aggregate forms;
shaping the mineral aggregate into a shape of the product; and
allowing the mineral aggregate to set, whereby the product is produced.

16. The method of claim 15 further comprising adding a seeding agent during stirring of the mineral aggregate, whereby the setting time of the mineral aggregate is affected.

17. The method of claim 16, wherein the seeding agent is finely ground bassanite or arcanite.

18. The method of claim 15, wherein a retarding agent effective to slow the setting of the mineral aggregate is added during stirring.

19. The method of claim 18, wherein the retarding agent is a weak acid selected from one or more of the group consisting of: acetic acid, citric acid, tartaric acid, ascorbic acid, boric acid and sodium gluconate.

20. (canceled)

21. The method of claim 15, wherein air is blown into the mineral aggregate during stirring, whereby a porosity of the produced product is increased.

22. The method of claim 15, wherein the mineral aggregate is shaped into the shape of the product by pouring into a mould.

23. The method of claim 15, wherein the mineral aggregate is shaped into the shape of a container for plants.

24. (canceled)

25. The method of claim 15, wherein setting of the mineral aggregate is accelerated by one or more of the following:
a. adding more finely ground precursor mineral mixture to the mineral aggregate;
b. increasing the relative proportion of arcanite to bassanite in the precursor mineral mixture; and
c. adding a seeding agent.

26. The method of claim 15, wherein the precursor mineral mixture comprises between about 30% w/w and about 97.5% w/w of bassanite (by weight of dry mixture), between about 2% w/w and about 50% w/w of magnesia (by weight of dry mixture), and between about 0.5% w/w and about 20% w/w of arcanite (by weight of dry mixture).

27. (canceled)

28. (canceled)

29. The method of claim 15, wherein the finely ground bassanite, magnesia and arcanite each independently have a particle size of between about 0.01 mm and about 2 mm.

30. The method of claim 1, wherein the amount of water used to hydrate the precursor mineral mixture is between about 10% w/w and about 60% w/w relative to the weight of the mixture.

31.-35. (canceled)
